(19) United States
(12) Patent Application Publication
(10) Pub. No.: US 2020/0074121 A1
(43) Pub. Date: Mar. 5, 2020

(54) Cryptographic Operation Processing Methods, Apparatuses, and Systems

(71) Applicant: Alibaba Group Holding Limited, Grand Cayman (KY)

(72) Inventor: Yingfang Fu, Beijing (CN)

(21) Appl. No.: 16/554,241

(22) Filed: Aug. 28, 2019

(30) Foreign Application Priority Data
Aug. 29, 2018 (CN) 201810996079.6

(51) Int. Cl. G06F 21/72; G06F 21/60; G06F 21/57; G06F 21/55; G06F 21/33

(52) U.S. Cl. CPC G06F 21/72; G06F 21/602; G06F 21/572; G06F 2221/034; G06F 21/33; G06F 2221/033; G06F 21/554

(57) ABSTRACT

Cryptographic operation processing methods, apparatuses and systems are disclosed. A method includes: a trusted forwarding module receiving a cryptographic operation request; and the trusted forwarding module transmitting the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations. The present disclosure solves the technical problems of failing to satisfy the independent needs of users with respect to measurements, lacking trusted computing resources, and having computational insecurity.

### CROSS REFERENCE TO RELATED PATENT APPLICATIONS

This application claims priority to Chinese Patent Application No. 201810996079.6, filed on 29 Aug. 2018 and entitled “Cryptographic Operation Processing Methods, Apparatuses, and Systems,” which is hereby incorporated by reference in its entirety.

### TECHNICAL FIELD

The present application relates to the field of cryptographic operation processing, and particularly to cryptographic operation processing methods, apparatuses, and systems.

### BACKGROUND

In related technologies, no distinctions are made between users' own requirements and security levels for cryptographic operation requests of the users. Either dynamic measurements are universally performed, or no dynamic measurements are performed for cryptographic operation requests sent by each user. This will lead to two extremes. First, dynamic measurements are still performed on cryptographic operation requests for some users who do not want dynamic measurements to be performed, or other situations that do not need to invoke dynamic measurements such as security levels of the cryptographic operation requests are low. Second, dynamic measurements are uniformly implemented for some highly reliable cryptographic operation requests, or other situations that do not need to invoke dynamic measurements such as users requiring fast cryptographic operations, and not wanting any dynamic measurements to be performed. Therefore, in the related technologies, for whether or not to perform a dynamic measurement for a cryptographic operation, adopting a unified setting will cause problems of failure in satisfying a user's own requirements for measurements, lack of trusted computing resources, and insecurity of computations.

No effective solution has been proposed yet for the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide cryptographic operation processing methods, apparatuses and systems, so as to solve at least the technical problems of failure in satisfying a user's own requirements for measurements, lack of trusted computing resources, and insecurity of computations.

In implementations, a cryptographic operation processing method is provided, which includes: a trusted forwarding module receiving a cryptographic operation request; and the trusted forwarding module transmitting the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

In implementations, a cryptographic operation processing method is further provided, which includes: a security chip receiving a cryptographic operation request, wherein the cryptographic operation request includes a dynamic measurement requirement, the dynamic measurement requirement is used for indicating that a dynamic measurement module is needed to be measured, the dynamic measurement module is a measurement entity used for measuring a firmware that performs cryptographic operations; the security chip measuring the dynamic measurement module according to the dynamic measurement requirement to obtain a measurement result; and the security chip triggering a cryptographic operation chip to perform a cryptographic operation when the measurement result indicates that an integrity of the dynamic measurement module is intact.

In implementations, a cryptographic operation processing method is further provided, which includes: a cryptographic operation chip receiving a cryptographic operation request, wherein the cryptographic operation request includes instruction information, the instruction information is used for indicating that a dynamic measurement module does not need to be measured, the dynamic measurement module is a measurement entity used for measuring a firmware that performs cryptographic operations; and the cryptographic operation chip performing a cryptographic operation in accordance with the cryptographic operation request.

In implementations, a cryptographic operation processing method is further provided, which includes: an encryption card receiving a cryptographic operation request in case of a dynamic measurement requirement; and the encryption card performing a cryptographic operation processing if the encryption card completes the dynamic measurement requirement, wherein the dynamic measurement requirement is used for indicating that a dynamic measurement module is needed to be measured, and the dynamic measurement module is a measurement entity used for measuring a firmware that performs cryptographic operations.

In implementations, a cryptographic operation processing method is further provided, which includes: a security chip in an encryption card receiving a cryptographic operation request in case of a dynamic measurement requirement; and the security chip in the encryption card triggering a cryptographic operation chip in the encryption card to perform cryptographic operation processing if the encryption card completes the measurement requirement, wherein the dynamic measurement requirement is used for indicating that a dynamic measurement module is needed to be measured, and the dynamic measurement module is a measurement entity used for measuring a firmware that performs cryptographic operations.

In implementations, a cryptographic operation processing method is further provided, which includes: a trusted forwarding module receiving a cryptographic operation request, wherein the cryptographic operation request includes an instruction information that indicates whether a dynamic measurement module is needed to be performed, and the dynamic measurement module is a measurement entity used for measuring a firmware that performs cryptographic operations; and the trusted forwarding module forwarding the cryptographic operation request to a security chip, if the instruction information indicates that the dynamic measurement module is needed to be measured; the security chip measuring the dynamic measurement module according to a dynamic measurement requirement to obtain a measurement result, and sending the measurement result to a cryptographic operation chip; and the cryptographic operation chip performing a cryptographic operation if the measurement result indicates that an integrity of the dynamic measurement module is intact.

In implementations, a cryptographic operation processing apparatus is further provided, which is applied to a trusted forwarding module, and includes: a first receiving module configured to receive a cryptographic operation request; and a sending module configured to send the cryptographic operation request to a security chip when the cryptographic operation request has a dynamic measurement requirement, wherein a cryptographic operation chip performs cryptographic operation processing after the security chip completes the dynamic measurement requirement, the dynamic measurement requirement is used for indicating that a dynamic measurement module is needed to be measured, and the dynamic measurement module is a measurement entity used for measuring a firmware that performs cryptographic operations.

In implementations, a cryptographic operation processing apparatus is further provided, which is applied to a security chip, and includes: a second receiving module configured to receive a cryptographic operation request, wherein the cryptographic operation request includes a dynamic measurement requirement, the dynamic measurement requirement is used for indicating that a dynamic measurement module is needed to be measured, and the dynamic measurement module is a measurement entity used for measuring a firmware that performs cryptographic operations; and a measurement module configured to measure the dynamic measurement module according to the dynamic measurement requirement to obtain a measurement result; and a triggering module configured to trigger a cryptographic operation chip to perform a cryptographic operation when the measurement result indicates that an integrity of the dynamic measurement module is intact.

In implementations, a cryptographic operation processing apparatus is further provided, which is applied to a cryptographic operation chip, and includes: a receiving module configured to receive a cryptographic operation request, wherein the cryptographic operation request includes instruction information, the instruction information is used for indicating that a dynamic measurement module is not needed to be measured, and the dynamic measurement module is a measurement entity used for measuring a firmware that performs cryptographic operations; and a computational module configured to execute a cryptographic operation according to the cryptographic operation request.

In implementations, a cryptographic operation processing system is further provided, which includes: a trusted forwarding module, a security chip, and a cryptographic operation chip, wherein the trusted forwarding module is configured to receive a cryptographic operation request, wherein the cryptographic operation request include instruction information indicating whether a dynamic measurement module is needed to be measured, and the dynamic measurement module is a measurement entity used for measuring a firmware that performs cryptographic operations; the trusted forwarding module is further configured to forward the cryptographic operation request to the security chip when the instruction information indicates that the dynamic measurement module is needed to be measured; the security chip is configured to measure the dynamic measurement module according to a dynamic measurement requirement to obtains a measurement result, and send the measurement result to the cryptographic operation chip; the cryptographic operation chip is configured to execute a cryptographic operation if the measurement result indicates that an integrity of the dynamic measurement module is intact.

In implementations, a storage media is provided, the storage media including a stored program, wherein when the program, when running, controls a device in which the storage media is located to perform any one of the above cryptographic operation processing methods.

In implementations, a processor is further provided, the processor being configured to execute a program, wherein the program, when executed, performs any one of the above cryptographic operation processing methods.

In the embodiments of the present disclosure, the trusted operation module receives a cryptographic operation request. When the cryptographic operation request has a dynamic measurement requirement, the trusted forwarding module sends the cryptographic operation request to the security chip. After the security chip completes the dynamic measurement requirement, a cryptographic operation chip performs cryptographic operation processing. The dynamic measurement requirement is used to indicate that a dynamic measurement module needs to be measured, and the dynamic measurement module is a measurement entity used for measuring a firmware that performs cryptographic operations. By monitoring a dynamic measurement requirement in a cryptographic operation request, and performing a dynamic measurement according to the dynamic measurement requirement, the purpose of performing a dynamic measurement according to a dynamic measurement requirement in a user request, thereby realizing the technical effects of improving user independence and saving computing resources, and thus solving the technical problems of failing to satisfy the independent needs of users with respect to measurements, lacking trusted computing resources, and having computational insecurity.

### BRIEF DESCRIPTION OF THE DRAWINGS

Accompanying drawings described herein are intended to provide a further understanding of the present disclosure, and are intended to be a part of the present application. Exemplary embodiments of the present application and descriptions thereof are used for describing the present disclosure, and are not construed to be improper limitations to the present disclosure. In the accompanying drawings:

FIG. 1 is a block diagram showing a hardware structure of a computer terminal (or mobile device) used for implementing a cryptographic operation processing method.

FIG. 2 is a structural block diagram of a trusted high-speed encryption card according to the embodiments of the present disclosure.

FIG. 3 is a schematic structural diagram of a trusted computing chip according to the embodiments of the present disclosure.

FIG. 4 is a schematic structural diagram of an FPGA chip according to the embodiments of the present disclosure.

FIG. 5 is a flowchart of a cryptographic operation processing method according to the first embodiment of the present disclosure.

FIG. 6 is a flowchart of another cryptographic operation processing method according to the first embodiment of the present disclosure.

FIG. 7 is a flowchart of another cryptographic operation processing method according to the first embodiment of the present disclosure.

FIG. 8 is a flowchart of a cryptographic operation processing method according to the second embodiment of the present disclosure.

FIG. 9 is a flowchart of a cryptographic operation processing method according to the third embodiment of the present disclosure.

FIG. 10 is a flowchart of a cryptographic operation processing method according to the fourth embodiment of the present disclosure.

FIG. 11 is a flowchart of a cryptographic operation processing method according to the fifth embodiment of the present disclosure.

FIG. 12 is a flowchart of a cryptographic operation processing method according to the sixth embodiment of the present disclosure.

FIG. 13 is a flowchart of another cryptographic operation processing method according sixth embodiment of the present disclosure.

FIG. 14 is a flowchart of a trusted high-speed cryptographic operation method according to a exemplary embodiment of the present disclosure.

FIG. 15 is a schematic structural diagram of a cryptographic operation processing apparatus according to the seventh embodiment of the present disclosure.

FIG. 16 is a schematic structural diagram of a cryptographic operation processing apparatus according to the eighth embodiment of the present disclosure.

FIG. 17 is a schematic structural diagram of a cryptographic operation processing apparatus according to the ninth embodiment of the present disclosure.

FIG. 18 is a schematic structural diagram of a cryptographic operation processing system according to the tenth embodiment of the present disclosure.

FIG. 19 is a block diagram showing a structure of a computer terminal according to the eleventh embodiment of the present disclosure.

### DETAILED DESCRIPTION

In order to enable one skilled in the art to understand the technical solutions of the present disclosure better, the technical solutions in the embodiments of the present disclosure are clearly and completely described herein with reference to the accompanying drawings in the embodiments of the present disclosure. Apparently, the described embodiments merely represent some and not all of the embodiments of the present disclosure. All other embodiments obtained by one skilled in the art based on the embodiments of the present disclosure without making any inventive effort shall fall within the scope of protection of the present disclosure.

It is to be understood that terms “first”, “second” and the like in the specification and claims of the present disclosure are used to distinguish between similar objects, and are not necessarily used to describe a particular order or sequence. It is to be understood that data so used may be interchanged whenever appropriate, so that the embodiments of the present disclosure described herein can be implemented in an order other than those illustrated or described herein. In addition, terms “including”, “containing” and their variants are intended to cover a non-exclusive inclusion. For example, a process, method, system, product, or device that includes a series of operations or units is not necessarily limited to these operations or units that are explicitly listed, but may also include other operations or units that are not explicitly listed or that are inherent to such processes, methods, products, or devices.

First, some nouns or terms that appear when the embodiments of the present application are described are applicable to the following explanations:

Trusted Computing: Trusted Computing is a trusted computing platform supported by hardware security modules in computing and communication systems to improve the overall security of a system.

Trusted Platform Module/Trusted Platform Control Module (TPM/TPCM): A security chip that provides integrity and authenticity for evidence, and is in general physically bound to a computing platform.

Trusted measurement: A practical method of a trusted measurement is an integrity measurement. The integrity measurement is to calculate a hash value of a code using a hash function, compare a stored hash value therewith to determine whether the code is changed, and make a corresponding judgment according to a comparison result by a system.

Field-programmable gate array: FPGA, specifically a class custom circuit, which can implement different logic gate functions by changing connections of logic blocks. Furthermore, the above logic blocks and connections can be changed according to designs, thereby implementing editable functions.

Trusted high-speed Data Encryption Card (or abbreviated as THSDC): A data encryption card with trusted functions.

Firmware: refers to a program stored in hardware that cannot be easily changed, and generally refers to basic hardware in which some of the above programs are located.

### First Embodiment

According to the embodiments of the present disclosure, a cryptographic operation processing method is also provided. It should be noted that operations shown in a flowchart of an accompanying drawing may be executed in a computer system such as a set of computer executable instructions. Also, although a logical order is shown in a flowchart, in some cases, operations that are shown or described may be performed in an order different than the ones described herein.

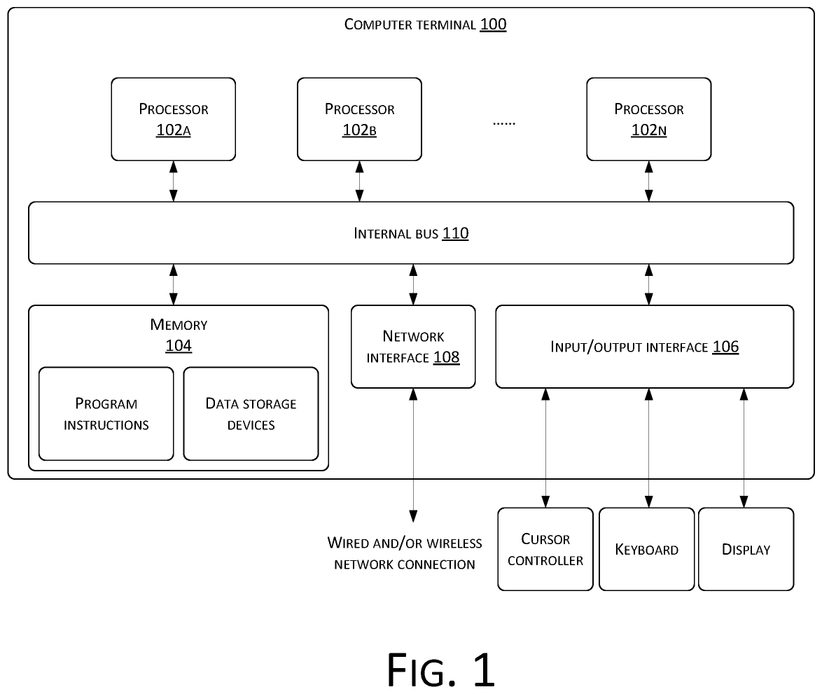

The method embodiment provided in the first embodiment of the present application can be executed in a mobile terminal, a computer terminal, etc. FIG. 1 is a block diagram showing a hardware configuration of a computer terminal 100 (or mobile device) used for implementing a cryptographic operation processing method. As shown in FIG. 1, the computer terminal 100 (or mobile device 100) may include one or more (102a, 102b, . . . , 102n shown in the figure) processors 102 (the processor 102 may include, but is not limited to, a processing device such as a micro-processor MCU or a programmable logic device FPGA), or a memory 104 used for storing data. In addition, the computer terminal 100 may further include: an input/output interface (I/O interface) 106, a universal serial bus (USB) port (which may be included as one of the ports of the I/O interface), a network interface 108, and an internal bus 110. In implementations, the computer terminal 100 may further include a transmission module, a display, a power source, and/or a camera. One skilled in the art can understand that the structure shown in FIG. 1 is merely illustrative, and does not limit the structure of the above electronic device. For example, the computer terminal 100 may also include more or fewer components than those shown in FIG. 1, or have a different configuration than the one shown in FIG. 1.

It should be noted that the one or more processors 102 and/or other data processing circuits may be generally referred to as “data processing circuits” herein. The data processing circuit may be embodied in whole or in part as software, hardware, firmware or any other combination. Moreover, the data processing circuit can be a single and independent processing module, or incorporated in whole or in part into any of the other components in the computer terminal 100 (or mobile device). As involved in the embodiments of the present application, the data processing circuit is used as a processor control (e.g., a selection of a variable resistance terminal path connected to an interface).

The memory 104 can be used to store software programs and modules of application software, such as program instructions/data storage devices corresponding to the cryptographic operation processing methods in the embodiments of the present disclosure. The processor(s) 102 perform(s) various functional applications and data processing by running software program(s) and module(s) stored in the memory 104, i.e., implementing a cryptographic operation processing method of an application program as described above. The memory 104 may include a high speed random access memory, and may also include a non-volatile memory such as one or more magnetic storage devices, a flash memory, or other non-volatile solid state memory. In some examples, the memory 104 may further include storage devices remotely located with respect to the processor(s) 102. These storage devices may be connected to the computer terminal 100 via a network. Examples of the network include, but are not limited to, the Internet, an intranet, a local area network, a mobile communication network, and a combination thereof.

The transmission module is configured to receive or transmit data via a network. Specific examples of the network may include a wireless network provided by a communication provider of the computer terminal 100. In an example, the transmission module includes a Network Interface Controller (NIC) that can be connected to other network devices through a base station to communicate with the Internet. In an example, the transmission module can be a Radio Frequency (RF) module configured to communicate with the Internet wirelessly.

The display can be, for example, a touch screen liquid crystal display (LCD) that enables a user to interact with a user interface of the computer terminal 100 (or mobile device).

FIG. 1 is a block diagram of a hardware structure, which can not only serve as an exemplary block diagram of the computer terminal 100 (or mobile device), but can also serve as an exemplary block diagram of the server as described above. In an optional embodiment, the computer terminal 100 (or mobile device) can be connected to one or more servers (e.g., a security server, a resource server, a game server, etc.) via a data network connection or an electrical connection. In an optional embodiment, the computer terminal 100 (or mobile device) may be any mobile computing device, etc. The data network connection can be a local area network connection, a wide area network connection, an Internet connection, or other types of data network connection. The computer terminal 100 (or mobile device) can execute to connect to a network service that is executed by a server (e.g., a security server) or a group of servers. A web server is a web-based user service, such as social networks, cloud resources, electronic mails, online payments, or other online applications.

Given the increasing popularity of computers, hardware attacks have become more and more common. An assurance of the integrity of service platforms and systems has received an increasing amount of attention. In technologies for checking the integrity of service platforms and systems, measurements are common technical means for protecting the integrity of platforms and systems. In particular, at certain moments, a measurement is performed on a target to obtain certain pieces of information of the target. Values of these pieces of information are compared with standard values of practical records to determine whether the integrity of the target is destroyed.

For example, in a scenario of a trusted high-speed encryption card, the high-speed encryption card includes a security chip used for credibility monitoring and a cryptographic operation chip used for performing cryptographic operations. To ensure the credibility of a cryptographic algorithm of the high-speed encryption card, a trusted measurement is needed to be performed on the trusted high-speed encryption card, and the trusted measurement of the trusted high-speed encryption card generally includes a static measurement and a dynamic measurement. The static measurement refers to the trusted high-speed encryption card automatically performing a trusted measurement on a cryptographic operation chip in the trusted high-speed encryption card after a system is started, and considering an associated cryptographic algorithm to be trustable in a running state of the system after affirming the cryptographic operation chip. The dynamic measurement refers to the trusted high-speed encryption card performing a trusted measurement on the cryptographic operation chip in the trusted high-speed encryption card every time when a cryptographic operation request of a user is received, and confirming that the cryptographic operation chip is trustable, i.e., ensuring the trustworthiness of the trusted high-speed encryption card under the cryptographic operation request. The measurement frequency of the static measurement is too small, and the reliability of the trusted high-speed encryption card is often not guaranteed, while the measurement frequency of the dynamic measurement is too high, and a measurement is made for each cryptographic operation request of a user. This fails to distinguish between different security levels and user's independent requirements of cryptographic operation requests, thus resulting in poor adaptations to the users' independent requirements, and wasting computing resources on some cryptographic operations requests that do not need to be dynamically measured.

Based on requirements of trusted computing specifications and trusted chip designs of TPCM and TPM, a trusted high-speed encryption card implements a platform trusted booting function from starting a machine to an operating system kernel, computational security for encrypting and decrypting sensitive service data, and interactions between two devices interact to ensure the legitimacy of platforms and identities of each other.

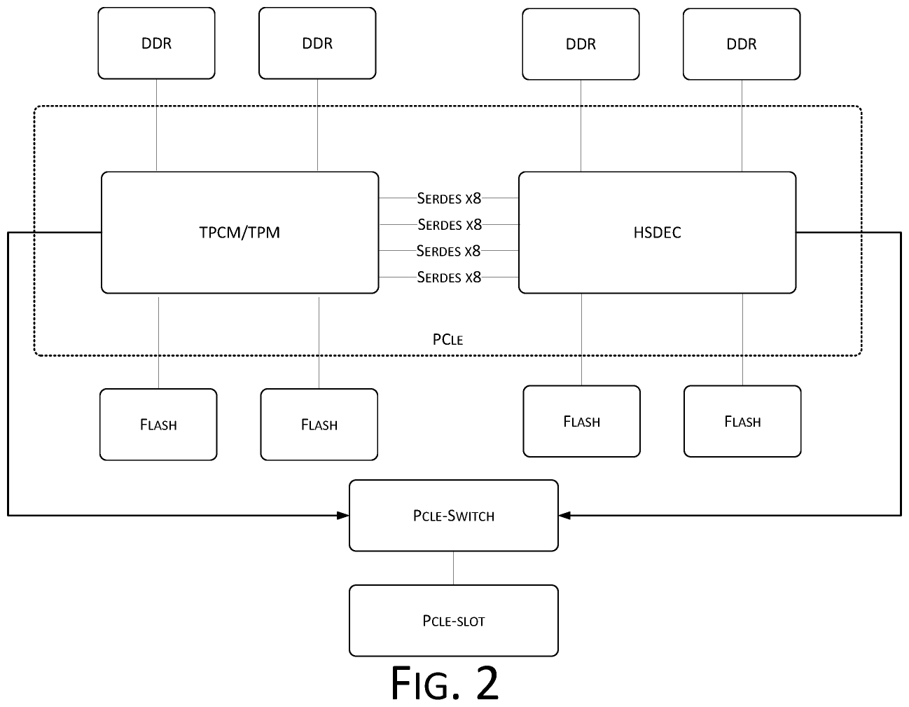

A trusted high-speed encryption card THSDC integrates a trusted computing chip and a FPGA high-speed encryption card into a PCIE card. FIG. 2 is a structural block diagram of a trusted high-speed encryption card according to the embodiments of the present disclosure. As shown in FIG. 2, data interactions between a trusted computing chip (hereinafter referred to as a security chip) and a high-speed data encryption card HSDEC (a FPGA chip is shown FIG. 2, and apparently, other high-speed cryptographic operation chips may also be used, which may also be referred to as cryptographic operation chips) may be performed through direct communications via an internal circuit of a board, without the need of going through a mapping of memory of a main machine (Host). A schematic diagram of a connection between THSDC and motherboard components is shown in FIG. 2, where interactions of commands and data between THSDC and trusted software-based TSB (or Trusted Software Stack TSS) are conducted through PCIE or SPI bus. By using a multiplexer to perform multiplexing for GPIO/SPI/I2C, measurements for BMC/BIOS and connections to associated controllers are implemented.

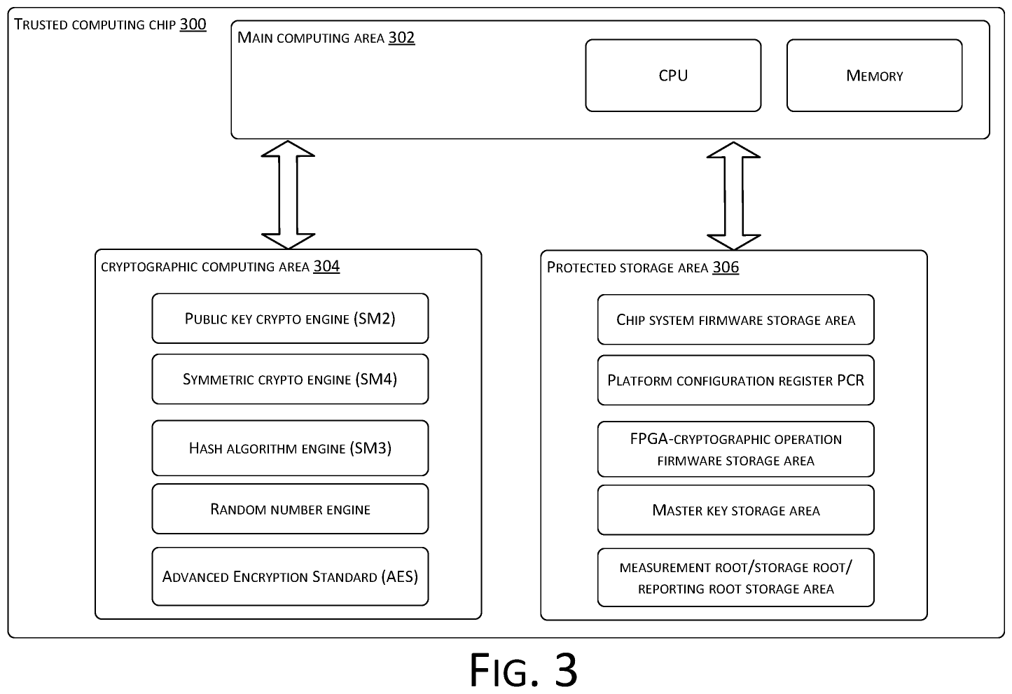

FIG. 3 is a schematic structural diagram of a trusted computing chip 300 according to the embodiments of the present disclosure. As shown in FIG. 3, a trusted computing chip mainly includes: a main computing area 302, a cryptographic computing area 304, and a storage area 306. The main computing area 302 includes a CPU and a memory, and is mainly responsible for general computations having low requirements for cryptographic computing power and storage capacity, but with high security requirements other than cryptographic operations. The cryptographic computing area 304 includes engines of different types of cryptographic algorithms, such as SM3, SM2, SM4, RSA, and AES algorithms, etc., and is mainly responsible for cryptographic operations having low requirements for cryptographic computing power and storage capacity. The storage area 306 includes a firmware storage, a PCR register storage, a master key storage (master key(s) that can be used to protect user key(s) generated in a FPGA chip), a FPGA cryptographic operation related firmware storage (mainly cryptographic algorithm, interfaces, timing, states, caches, etc.), and a measurement root/reporting root/storage root storage.

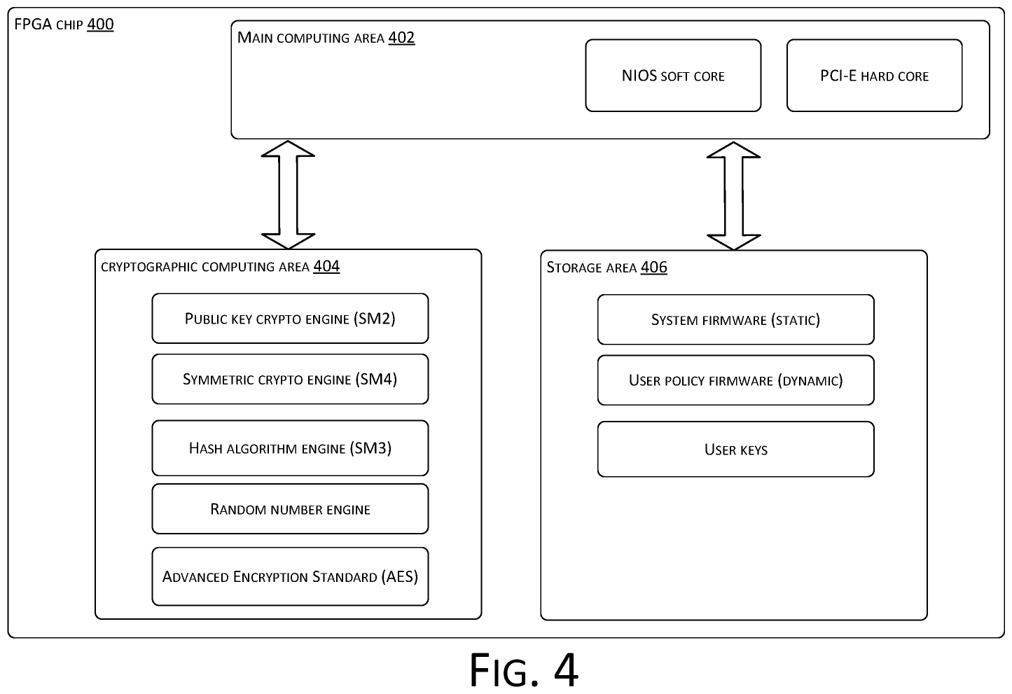

FIG. 4 is a schematic structural diagram of an FPGA chip 400 according to the embodiments of the present disclosure. As shown in FIG. 4, a FPGA chip mainly includes: a main computing area 402, a cryptographic operation area 404, and a storage area 406. The main computing area 402 mainly includes: a NIOS soft core processor with a built-in FPGA chip, and a PCIE hard core, which implement functions of a controller module and an interface module respectively. The cryptographic operation area 404 is mainly responsible for cryptographic operations having relatively high requirements for cryptographic computing power and storage capacity. A cryptographic algorithm thereof can perform dynamic loading within a board according to cryptographic algorithmic requirements of an actual application defined by a user policy of a user firmware dynamic storage area. Before loading, verifies integrity and legitimacy thereof are verified by a trusted measurement root, and loading is then performed. The storage area 406 mainly includes: a system firmware static storage area which is only readable and not writable, a user firmware dynamic storage area which is readable and writable and mainly include dynamic policies of user configurations, and user key(s) obtained by the FPGA chip after performing calculations through cryptographic operation algorithm(s).

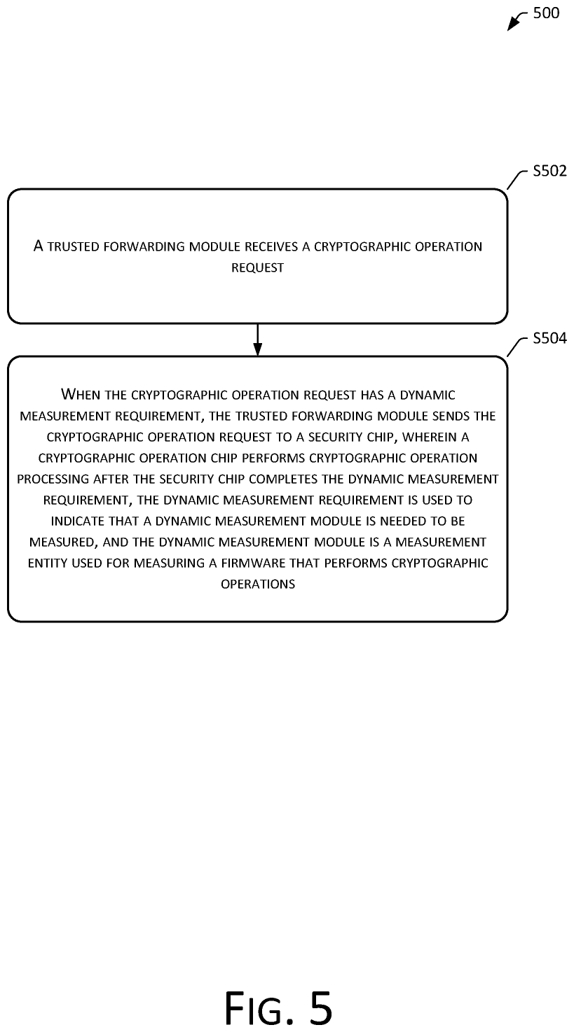

Based on the above operating environment, the present application provides a cryptographic operation processing method. FIG. 5 is a flowchart of a cryptographic operation processing method 500 according to the first embodiment of the present disclosure. As shown in FIG. 5, the cryptographic operation processing method 500 includes the following operations:

Operation S502: A trusted forwarding module receives a cryptographic operation request.

In implementations, the cryptographic operation request may be a request of a user to a trusted high-speed encryption card for performing an encryption operation. The cryptographic operation request may be a request directly sent by the user to the trusted high-speed encryption card. The trusted high-speed encryption card directly receives the cryptographic operation request, and performs an encryption operation corresponding to the cryptographic operation request.

In implementations, the cryptographic operation request may also be an operation request sent to the trusted high-speed encryption card after certain processing is performed. The cryptographic operation request has an optimal performance in response to a mode of such processing after such processing is performed. For example, after de-noising is performed on a cryptographic operation request, the cryptographic operation request can be made more accurate. For another example, a cryptographic operation request has a performance of safer transmission after encryption and decryption are performed thereon.

In implementations, the cryptographic operation request may also be processed by a trusted forwarding module. The trusted forwarding module is configured to authenticate the legitimacy of the cryptographic operation request, i.e., authentication is performed on the cryptographic operation request. When the cryptographic operation request successfully passes the authentication, the cryptographic operation request is forwarded to the trusted high-speed encryption card.

In implementations, the trusted forwarding module may perform certain processing on the cryptographic operation request, for example, monitoring a dynamic measurement requirement of the cryptographic operation request. The dynamic measurement requirement is used to instruct whether the trusted high-speed encryption card is to perform a dynamic measurement on the cryptographic operation request. If the cryptographic operation request has a dynamic measurement requirement, a determination is made that a dynamic measurement is requested by a user to be performed on the cryptographic operation request, and the trusted high-speed encryption card performs the dynamic measurement on the cryptographic operation request. By effectively performing a dynamic measurement on a cryptographic operation request with respect to a user's needs, encryption processing of some cryptographic operation requests that do not require dynamic measurements is effectively simplified, and the computational complexity of the trusted high-speed encryption card is reduced. The computing speed is improved, and resources of the trusted high-speed encryption card are saved.

In implementations, after the cryptographic operation request processed by the trusted forwarding module is forwarded to the trusted high-speed encryption card, a cryptographic operation is performed by the trusted high-speed encryption card.

In implementations, the trusted forwarding module may be a forwarding chip, a forwarding module, or the like, in a trusted high-speed encryption card, or may be a forwarding apparatus other than a trusted high-speed encryption card, or a functional module of an upper-level information processing apparatus of a trusted high-speed encryption card, for example, a sending module of a human-machine interaction apparatus, which is configured to send a cryptographic operation request that is received from a user to a lower-level information processing apparatus of the human-machine interaction apparatus, wherein the human-machine interaction apparatus is used for converting requirements inputted by the user into electrical signals.

Operation S504: When the cryptographic operation request has a dynamic measurement requirement, the trusted forwarding module sends the cryptographic operation request to a security chip, wherein a cryptographic operation chip performs cryptographic operation processing after the security chip completes the dynamic measurement requirement, the dynamic measurement requirement is used to indicate that a dynamic measurement module is needed to be measured, and the dynamic measurement module is a measurement entity used for measuring a firmware that performs cryptographic operations.

In implementations, when the trusted forwarding module detects that a cryptographic operation request has a dynamic measurement requirement, the trusted forwarding module sends the cryptographic operation request to a security chip. The security chip belongs to the trusted high-speed encryption card, and is used for responding to the dynamic measurement requirement in the cryptographic operation request, and performing a trusted measurement on a dynamic measurement module in the trusted high-speed encryption card. When the dynamic measurement module is trusted, the dynamic measurement module is used to perform a measurement on a firmware that performs cryptographic operations. When the firmware that performs cryptographic operations is successfully measured, a cryptographic operation chip in the trusted high-speed encryption card is used to perform an encryption operation responsive to the cryptographic operation request.

In implementations, the security chip completes the dynamic measurement requirement, or in other words, the security chip performs a measurement in response to the dynamic measurement requirement. This may be to perform a measurement on a cryptographic algorithm, perform a measurement on a cryptographic operation chip, or perform a measurement on a measurement entity that measures the cryptographic algorithm, so that the credibility of cryptographic operations of the cryptographic operation chip is improved.

In implementations, the cryptographic operation chip performs a cryptographic operation, or in other words, the trusted high-speed encryption card performs a cryptographic operation in response to the cryptographic operation request.

In implementations, the dynamic measurement module may be a functional module used for implementing a dynamic measurement, or may also be a measurement entity used for implementing a dynamic measurement action by combining various functional modules. For example, the dynamic measurement module may a measurement entity used for measuring a firmware that performs cryptographic operations. The firmware that performs cryptographic operations may include a security chip that initiates a cryptographic operation, wherein the security chip may be a security module in a trusted high-speed encryption card.

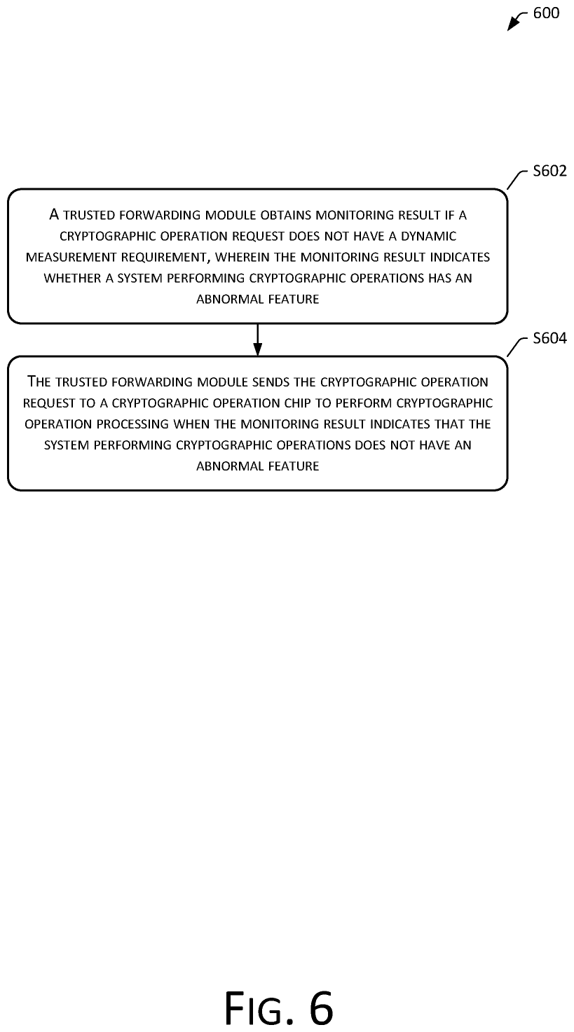

In implementations, FIG. 6 is a flowchart of another cryptographic operation processing method 600 according to the first embodiment of the present disclosure. In addition or alternative to the operations as shown in FIG. 5, the cryptographic operation processing method 600 may further include the following operations.

Operation S602: A trusted forwarding module obtains monitoring result if a cryptographic operation request does not have a dynamic measurement requirement, wherein the monitoring result indicates whether a system performing cryptographic operations has an abnormal feature.

Operation S604: The trusted forwarding module sends the cryptographic operation request to a cryptographic operation chip to perform cryptographic operation processing when the monitoring result indicates that the system performing cryptographic operations does not have an abnormal feature.

In implementations, if the cryptographic operation request does not have a dynamic measurement requirement, this indicates that no determination about whether a user needs a dynamic measurement to be performed for the cryptographic operation request can be made. A cryptographic operation request having no dynamic measurement requirement may be a cryptographic operation request that is not specified by a user for performing a dynamic measurement, or may be a cryptographic operation request that a user has forgotten to specify to perform a dynamic measurement. In case when a user's requirement is not clear, the credibility of a cryptographic operating system can be determined. When the cryptographic operating system is trusted, any cryptographic operation requirements can perform effective cryptographic operations.

In implementations, the monitoring result is used to indicate whether the credibility of the system performing cryptographic operations has an abnormal feature, and the abnormal feature indicates that the cryptographic operating system may be not trustable. This may affect a process of cryptographic operations. The monitoring result may be outputted by a monitoring module used for monitoring operating parameters of the cryptographic operating system. The monitoring module may be a self-monitoring module located in a trusted high-speed encryption card, or may be a monitoring apparatus located outside the trusted high-speed encryption card, or a monitoring module of other devices (systems) other than the trusted high-speed encryption card.

In implementations, if the monitoring result obtained by the trusted forwarding module indicates that the cryptographic operating system does not have any abnormality, the cryptographic operating system can be determined to be normal, and can perform cryptographic operations normally. The cryptographic operation request may be sent to a cryptographic operation chip in a trusted high-speed encryption card for performing cryptographic operation processing. This can ensure that the cryptographic operation request is received for performing a cryptographic operation under the circumstance that the cryptographic operating system is error free.

In implementations, the cryptographic operation method further includes: the trusted forwarding module obtaining a security level of a user who sends the cryptographic operation request when the monitoring result indicates that the system performing cryptographic operations has an abnormal feature; the trusted forwarding module sending the cryptographic operation request to a security chip when the security level of the user is a high security level, wherein the security level of the user includes the high security level and a low security level.

In implementations, if the monitoring result indicates that the cryptographic operating system is abnormal, this indicates that the cryptographic operating system may be not trustable. Before a trusted measurement is performed for the cryptographic operating system, whether the cryptographic operating system cannot perform valid cryptographic operations cannot be determined. In order to ensure normal cryptographic operations of the cryptographic operating system, it is necessary to perform a trusted measurement on the cryptographic operating system in cases when the monitoring result indicates that the cryptographic operating system has an abnormal feature, and determine whether the cryptographic operating system cannot perform valid cryptographic operations. However, cryptographic operation requests of users may have different requirements. Some cryptographic operation requests may not be required by a user to undergo a dynamic measurement. In order to prevent a waste of computing resources for performing a trusted measurement on a system when a dynamic measurement requirement is not needed, a user's requirement may be confirmed first. A trusted measurement is performed on a cryptographic operating system operation if the user may need a dynamic measurement.

In implementations, in the foregoing situations when an intention of a user regarding whether to perform a dynamic measurement on the cryptographic request is unclear, the monitoring result being abnormal indicates that the cryptographic operating system has a possibility of being not trustable, which may lead to an occurrence of an operation error for a cryptographic operation request having a relatively high importance (a user needs a dynamic measurement to be performed). In order to avoid occurrences of such situations, when a cryptographic operation request is relatively important, a trusted measurement is performed on an associated cryptographic operating system. Under the circumstance that the cryptographic system is trusted, an operation is performed for the cryptographic operation request, thus being able to effectively reduce an error rate of an associated cryptographic operation, enhancing the processing power of the cryptographic operating system, and being more user-friendly.

In implementations, when the cryptographic operation request is relatively important, during determination, a level classification for the importance of the cryptographic operation request may be made, or a level classification indicating the cryptographic operation request may be made. An example is the above security level of the user. Specifically, security levels of a user as described above are divided into a high security level where a cryptographic operation request is relatively important, and a low security level where a cryptographic operation request is relatively unimportant.

In implementations, the high security level and the low security level may be one level or several levels. For example, level classifications of users are five levels. When trusted requirements of users are relatively common, first four user classification levels are allocated as high security levels, and the last user classification level is allocated as a low security level. When most users do not require trusted requirements, the first user classification level can be allocated as a high security level, and the remaining classification levels are allocated as low security levels. Such division of high security level(s) and low security level(s) may vary depending on situations.

In implementations, if the security level of the user is a high security level, a determination is made that a dynamic measurement is required by the user to be performed for the cryptographic operation request. The trusted forwarding module is used to send the cryptographic operation request to the security chip for performing the dynamic measurement.

In implementations, the cryptographic operation method further includes: the trusted forwarding module sending prompt information indicating that the system is at risk when the security level of the user is a low security level; and the trusted forwarding module sending the cryptographic operation request to the security chip in response to receiving an instruction that a dynamic measurement that needs to be started.

In implementations, when the security level of the user is a low security level, there is no guarantee that a dynamic measurement does not need to be performed for the cryptographic operation request. Therefore, when the security level of the user is a low security level, a prompt is given to the user for the user to make a determination, which can effectively prevent the user having a low security level from forgetting to determine whether a dynamic measurement is to be performed, thus failing to perform an effective encryption operation on the cryptographic operation request.

In implementations, the prompt information may be prompt information prompting the user to re-determine whether a dynamic measurement is performed. However, a situation when the user of the low security level forgets to determine whether a dynamic measurement is performed and an abnormality occurs in the system is relatively rare. Therefore, the user can be directly prompted that an abnormality occurs in the system in order to draw an attention from the user.

In implementations, after receiving the prompt information, the user confirms that the cryptographic operation request is indeed under a situation that a dynamic measurement is needed to be performed, and sends an instruction to start the dynamic measurement for the cryptographic operating system. The trusted forwarding module sends the cryptographic operation request to the security chip for performing the dynamic measurement.

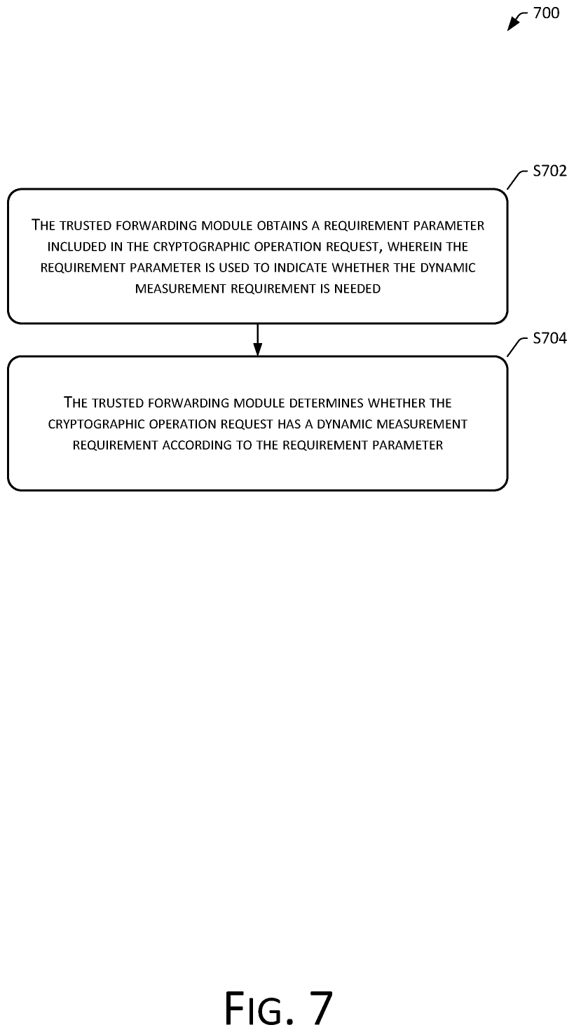

FIG. 7 is a flowchart of another cryptographic operation processing method 700 according to the first embodiment of the present disclosure. As shown in FIG. 7, after the trusted forwarding module receives the cryptographic operation request (e.g., at operation S502), the method 700 further includes the following operations.

Operation S702: The trusted forwarding module obtains a requirement parameter included in the cryptographic operation request, wherein the requirement parameter is used to indicate whether the dynamic measurement requirement is needed.

Operation S704: The trusted forwarding module determines whether the cryptographic operation request has a dynamic measurement requirement according to the requirement parameter.

In implementations, the cryptographic operation request may include an instruction about whether a dynamic measurement is performed, and may further include a requirement parameter used for indicating whether the dynamic measurement is performed. According to the above instruction or requirement parameter, a determination can be made about whether the dynamic measurement is required by the user to be performed for the cryptographic operation request.

In implementations, when the requirement parameter is included in the cryptographic operation request, the instruction represented by the requirement parameter is first determined, and the trusted forwarding module determines whether the cryptographic operation request has a dynamic measurement requirement according to the requirement parameter. Execution bod(ies) of the above operations may also be other device(s) or functional module(s).

In implementations, after the trusted forwarding module receives the cryptographic operation request, the method further includes: the trusted forwarding module verifying the legitimacy of the cryptographic operation request according to a user platform identity certificate included in the cryptographic operation request, and allowing the forwarding of the cryptographic operation request upon successful verification.

In implementations, if the user requires a dynamic measurement, the user may be illegitimate. The legitimacy of the user needs to be determined. The cryptographic operation request may include a parameter indicating the legitimacy of the user, for example, the user's platform identity certificate, etc. After the user's platform identity certificate is successfully verified, the user is considered to be legitimate, and the user is allowed to request a dynamic measurement for the cryptographic operation request. When the above operation is performed by the trusted forwarding module, the cryptographic operation request is forwarded.

The embodiments of the present disclosure use a trusted operation module to receive a cryptographic operation request. When the cryptographic operation request has a dynamic measurement requirement, the trusted forwarding module sends the cryptographic operation request to a security chip. After the security chip completes the dynamic measurement requirement, a cryptographic operation chip performs cryptographic operation processing. The dynamic measurement requirement is used to indicate that a dynamic measurement module needs to be measured, and the dynamic measurement module is a measurement entity used for measuring a firmware that performs cryptographic operations. By monitoring a dynamic measurement requirement in a cryptographic operation request, and performing a dynamic measurement according to the dynamic measurement requirement, the purpose of performing a dynamic measurement according to a dynamic measurement requirement in a user request, thereby realizing the technical effects of improving user independence and saving computing resources, and thus solving the technical problems of failing to satisfy the independent needs of users with respect to measurements, lacking trusted computing resources, and having computational insecurity.

### Second Embodiment

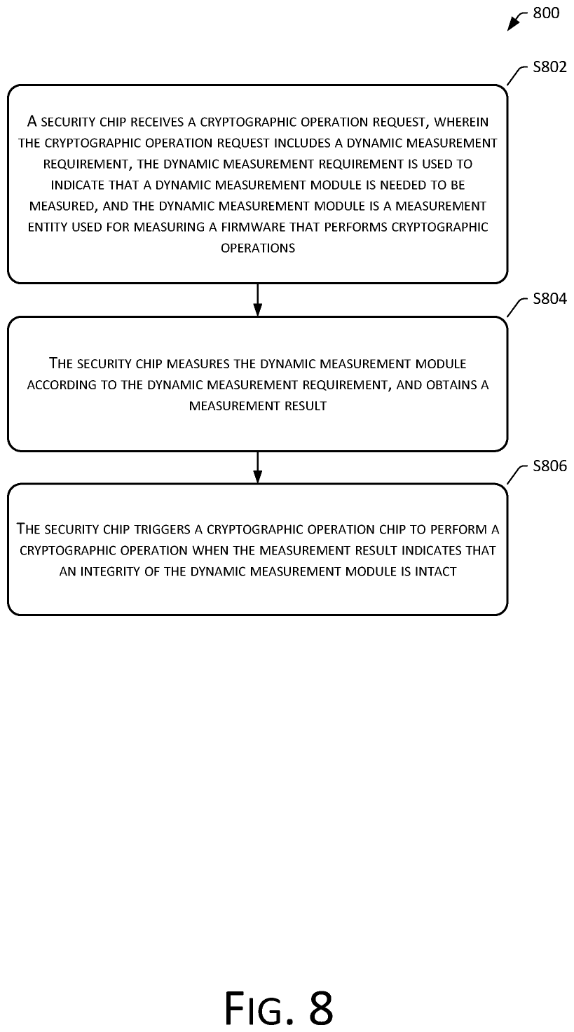

A method embodiment of a method for processing a cryptographic operation method is also provided according to the embodiments of the present disclosure. FIG. 8 is a flowchart of a cryptographic operation processing method 800 according to the second embodiment of the present disclosure. As shown in FIG. 8, the method 800 may include the following operations.

Operation S802: A security chip receives a cryptographic operation request, wherein the cryptographic operation request includes a dynamic measurement requirement, the dynamic measurement requirement is used to indicate that a dynamic measurement module is needed to be measured, and the dynamic measurement module is a measurement entity used for measuring a firmware that performs cryptographic operations.

In implementations, an execution entity of the foregoing operation is a security chip used for performing a trusted measurement. The security chip may be a security chip or a security module in a trusted high-speed encryption card, or may be or an apparatus or a security module other than a trusted high-speed encryption card.

In implementations, the cryptographic operation request is sent by a user, and is used to instruct a trusted high-speed encryption card to perform an encryption operation. After receiving the cryptographic operation request, the security chip determines whether to perform a dynamic measurement operation according to a dynamic measurement requirement in the cryptographic operation request. When the cryptographic operation request includes a dynamic measurement requirement, and the dynamic measurement requirement indicates that a dynamic measurement is needed, the security chip performs the dynamic measurement.

Operation S804: The security chip measures the dynamic measurement module according to the dynamic measurement requirement, and obtains a measurement result.

In implementations, when the security chip performs a measurement in response to the dynamic measurement requirement, a cryptographic algorithm may be measured, a cryptographic operation chip may be measured, or a measurement entity that measures the cryptographic algorithm may be measured, to improve the credibility of cryptographic operations of the cryptographic operation chip.

In implementations, the dynamic measurement requirement and the dynamic measurement module as described above may be the same as the dynamic measurement requirement and the dynamic measurement module in the first embodiment.

In implementations, the measurement result is whether the dynamic measurement module is trusted, and may also be whether the dynamic measurement module is intact, or the like, and is used to indicate whether a cryptographic operation that is performed is trusted.

Operation S806: The security chip triggers a cryptographic operation chip to perform a cryptographic operation when the measurement result indicates that an integrity of the dynamic measurement module is intact.

In implementations, when the measurement result is that an integrity of the dynamic measurement module is intact, this indicates that a cryptographic operating system can perform valid cryptographic operations, and the security chip triggers a cryptographic operation chip to perform a cryptographic operation according to the cryptographic operation request. This effectively guarantees that the credibility of a cryptographic operation is measured when a dynamic measurement is needed to be performed on a cryptographic operation request. When the cryptographic operation is trusted, the cryptographic operation is performed to ensure the validity of the cryptographic operation.

In implementations, after the security chip receives the cryptographic operation request, the method further includes: the security chip verifying the legitimacy of the cryptographic operation request, and allowing the dynamic measurement module to be measured upon successful verification.

In implementations, when the user needs a dynamic measurement, the user may be illegitimate. Therefore, the legitimacy of the user needs to be determined. The cryptographic operation request may include a parameter indicating the legitimacy of the user, for example, the user's platform identity certificate, etc. After the user's platform identity certificate is verified, the user is considered to be legitimate, and the user is allowed to request a dynamic measurement of the cryptographic operation request. After the security chip determines that the user is legitimate, the dynamic measurement module is allowed to perform a measurement.

In the embodiments of the present disclosure, a security chip is used to receive a cryptographic operation request. The cryptographic operation request includes a dynamic measurement requirement, and the dynamic measurement requirement is used to indicate that a dynamic measurement module is needed to be measured. The dynamic measurement module is a measurement entity used for measuring a firmware that performs cryptographic operations. The security chip measures the dynamic measurement module according to the dynamic measurement requirement, and obtains a measurement result. The security chip triggers a cryptographic operation chip to perform a cryptographic operation when the measurement result indicates that an integrity of the dynamic measurement module is intact. By monitoring a dynamic measurement requirement in a cryptographic operation request and performing a dynamic measurement according to the dynamic requirement, the purpose of performing a dynamic measurement according to the dynamic measurement requirement in a user request is achieved, thereby realizing the technical effects of improving user independence and saving computing resource. This thereby solves the technical problems of a failure in satisfying user independent needs of measurements, a lack of trusted computing resources, and an insecurity of computations.

### Third Embodiment

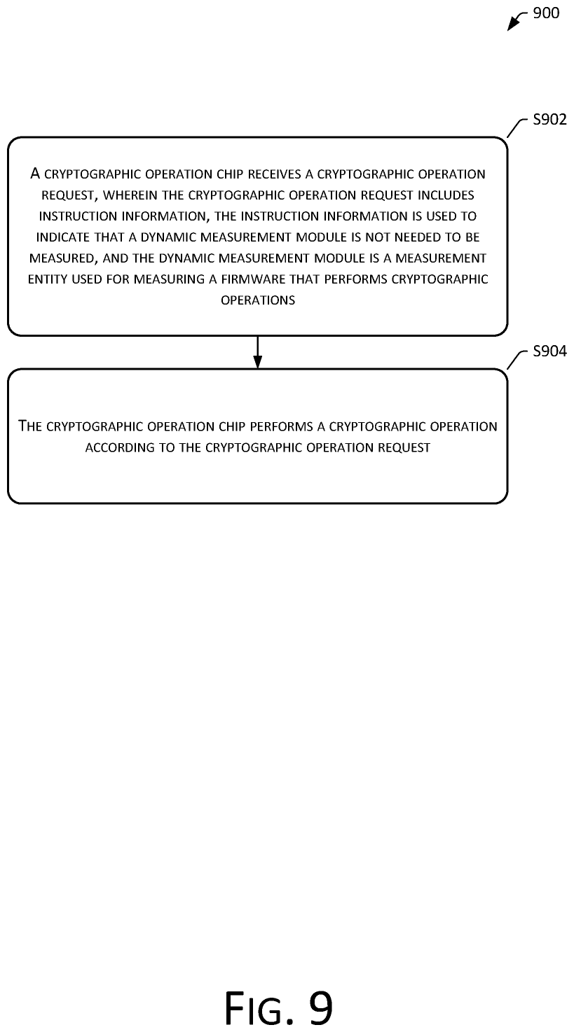

According to the embodiments of the present disclosure, a method embodiment of a cryptographic operation processing method is further provided. FIG. 9 is a flowchart of a cryptographic operation processing method 900 according to the third embodiment of the present disclosure. As shown in FIG. 9, the cryptographic operation processing method 900 performs the following operations.

Operation S902: A cryptographic operation chip receives a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations.

In implementations, an execution body of the foregoing operation is a cryptographic operation chip used for performing cryptographic operations. After receiving a cryptographic operation request, the cryptographic operation chip determines whether a dynamic measurement is needed to be performed on a dynamic measurement module based on instruction information included in the cryptographic operation request. When the instruction information included in the cryptographic operation request indicates that the dynamic measurement module is not required to be measured, this indicates that the dynamic measurement is confirmed not to be required for the cryptographic operation request. The cryptographic operation chip directly performs a cryptographic operation according to the cryptographic operation request, thereby effectively saving computing resources.

The dynamic measurement requirement and the dynamic measurement module described above may be the same as the dynamic measurement requirement and the dynamic measurement module in the first embodiment.

Operation S904: The cryptographic operation chip performs a cryptographic operation according to the cryptographic operation request.

In implementations, the cryptographic operation chip may be a cryptographic operation chip used for performing cryptographic operations in a trusted high-speed encryption card, or may be a cryptographic computing apparatus other than a trusted high-speed encryption card, or a cryptographic operation module.

In the embodiments of the present disclosure, a cryptographic operation chip receives a cryptographic operation request, wherein the cryptographic operation request includes instruction information. The instruction information is used to indicate that a dynamic measurement module is not required to be measured, and the dynamic measurement module is a measurement entity used for measuring a firmware that performs cryptographic operations. The cryptographic operation chip performs a cryptographic operation according to the cryptographic operation request, monitors the dynamic measurement requirement in the cryptographic operation request, and performs a dynamic measurement according to the dynamic requirement, thus achieving the purpose of performing a dynamic measurement according to a dynamic measurement requirement of a user request. This thereby achieves the technical effects of improving user autonomy and saving computing resources, and thus solving the technical problems of a failure in satisfying user self-determination of measurements, a lack of trusted computing resources and an insecurity of computations.

### Fourth Embodiment

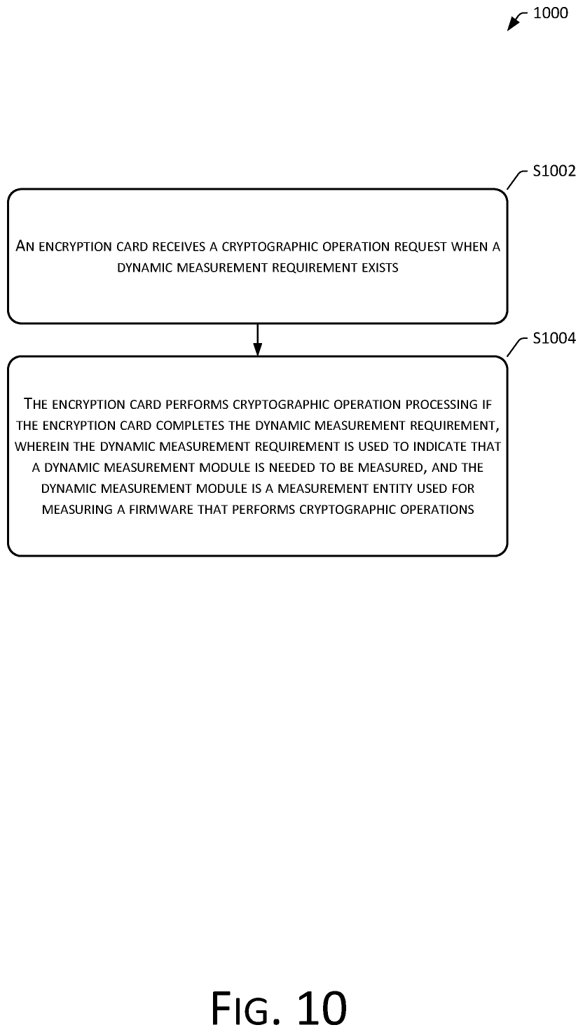

According to the embodiments of the present disclosure, a method embodiment of a cryptographic operation processing method is further provided. FIG. 10 is a flowchart of a cryptographic operation processing method 1000 according to the fourth embodiment of the present disclosure. As shown in FIG. 10, the method 1000 may include the following operations.

Operation S1002: An encryption card receives a cryptographic operation request when a dynamic measurement requirement exists.

In implementations, monitoring of the dynamic measurement requirement may be performed by a monitoring apparatus other than a trusted high-speed encryption card, such as a trusted forwarding module. The monitoring apparatus detects a dynamic measurement requirement in a cryptographic operation request, and an encryption card accepts the cryptographic operation request. The encryption card can perform a cryptographic operation according to the cryptographic operation request, and can also perform a dynamic measurement according to the dynamic measurement requirement.

Operation S1004: The encryption card performs cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

In implementations, the encryption card responds to the dynamic measurement requirement, and a dynamic measurement is performed by the encryption card first. In response to confirming that the cryptographic operation is trusted, an encryption operation is then performed by the encryption card to ensure the accuracy and validity of the cryptographic operation.

In implementations, the dynamic measurement or the cryptographic operation may be performed by different functional modules in the encryption card when being performed by the encryption card. For example, when the encryption card is a trusted high-speed encryption card, a security chip in the trusted high-speed encryption card is used to perform the dynamic measurement, and a cryptographic operation chip in the trusted high-speed encryption card is to perform the cryptographic operation.

The dynamic measurement requirement and the dynamic measurement module described above may be the same as the dynamic measurement requirement and the dynamic measurement module in the first embodiment.

In the embodiments of the present disclosure, when a dynamic measurement requirement exists, an encryption card receives a cryptographic operation request. If the encryption card completes the dynamic measurement requirement, the encryption card performs cryptographic operation processing, wherein the dynamic measurement requirement is used to indicate that a dynamic measurement module needs to be measures, and the dynamic measurement module is a measurement entity used for measuring a firmware that performs cryptographic operations. By monitoring a dynamic measurement requirement in a cryptographic operation request, and performing a dynamic measurement according to the dynamic requirement, the purpose of performing a dynamic measurement according to a dynamic measurement requirement of a user request is achieved. This thereby achieves the technical effects of improving user autonomy and saving computing resources, and thus solving the technical problems of an inability of satisfying user self-determination of measurements, a lack of trusted computing resources and an insecurity of computations.

### Fifth Embodiment

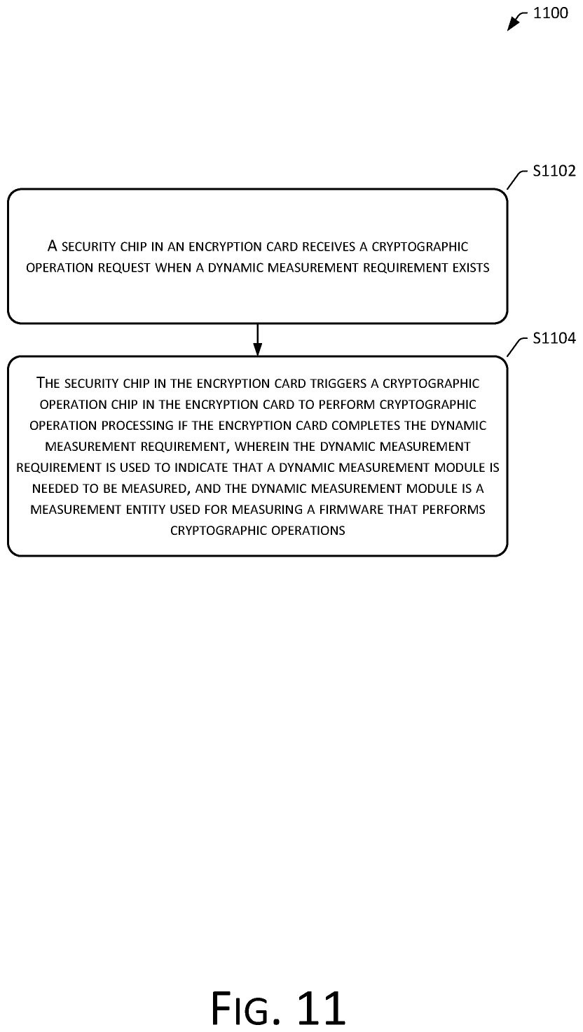

A method embodiment of a cryptographic operation processing method is provided according to the embodiments of the present disclosure. FIG. 11 is a flowchart of a cryptographic operation processing method 1100 according to the fifth embodiment of the present disclosure. As shown in FIG. 11, the method 1100 may include the following operations.

Operation S1102: A security chip in an encryption card receives a cryptographic operation request when a dynamic measurement requirement exists.

In implementations, monitoring of the dynamic measurement requirement may be performed by a monitoring apparatus other than a trusted high-speed encryption card, such as a trusted forwarding module. The monitoring apparatus detects a dynamic measurement requirement in a cryptographic operation request, and the cryptographic operation request is accepted by a security chip in the encryption card. The security chip can perform a dynamic measurement according to the dynamic measurement requirement.

Operation S1104: The security chip in the encryption card triggers a cryptographic operation chip in the encryption card to perform cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

In implementations, when the security chip completes the dynamic measurement requirement, the cryptographic operation is determined to be trusted, and the cryptographic operation is performed by the cryptographic operation chip in the encryption card. The cryptographic operation chip is triggered by the security chip when the cryptographic operation is confirmed to be trusted, and the cryptographic operation is performed after the cryptographic operation chip is triggered.

The dynamic measurement requirement and the dynamic measurement module described above may be the same as the dynamic measurement requirement and the dynamic measurement module in the first embodiment.

In the embodiments of the present disclosure, when a dynamic measurement requirement exists, a security chip in an encryption card receives a cryptographic operation request. If the encryption card completes the dynamic measurement requirement, the security chip in the encryption card triggers a cryptographic operation chip in the encryption card to perform cryptographic operation processing, wherein the dynamic measurement requirement is used to indicate that a dynamic measurement module needs to be measures, and the dynamic measurement module is a measurement entity used for measuring a firmware that performs cryptographic operations. By monitoring a dynamic measurement requirement in a cryptographic operation request, and performing a dynamic measurement according to the dynamic requirement, the purpose of performing a dynamic measurement according to a dynamic measurement requirement of a user request is achieved. This thereby achieves the technical effects of improving user autonomy and saving computing resources, and thus solving the technical problems of a failure in satisfying user self-determination of measurements, a lack of trusted computing resources and an insecurity of computations.

### Sixth Embodiment

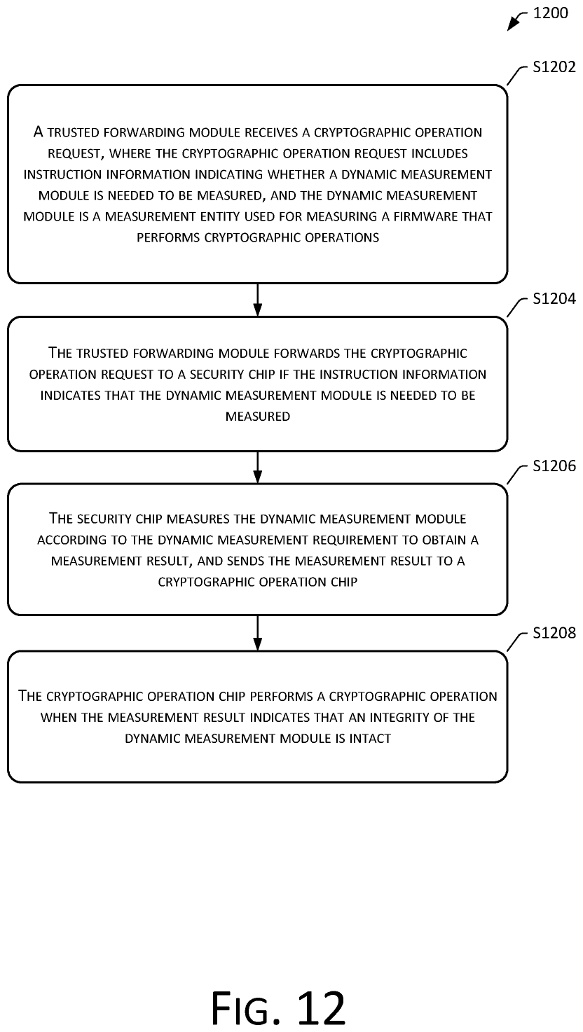

According to the embodiments of the present disclosure, a method embodiment of a cryptographic operation processing method is also provided. FIG. 12 is a flowchart of a cryptographic operation processing method 1200 according to the sixth embodiment of the present disclosure. As shown in FIG. 12, the method 1200 may include the following operations.

Operation S1202: A trusted forwarding module receives a cryptographic operation request, where the cryptographic operation request includes instruction information indicating whether a dynamic measurement module is needed to be measured, and the dynamic measurement module is a measurement entity used for measuring a firmware that performs cryptographic operations.

In implementations, the trusted forwarding module receives the cryptographic operation request, and determines whether to perform a dynamic measurement according to the instruction information in the cryptographic operation request. When the instruction information indicates that the cryptographic operation request does not need a dynamic measurement, the cryptographic operation request is directly forwarded to an encryption card or a cryptographic operation chip to perform a cryptographic operation. The instruction information can be used to indicate that the cryptographic operation request does not need to be dynamically measured.

The above dynamic measurement module can be the same as the dynamic measurement module in the first embodiment.

Operation S1204: The trusted forwarding module forwards the cryptographic operation request to a security chip if the instruction information indicates that the dynamic measurement module is needed to be measured.

In implementations, after receiving the cryptographic operation request including the instruction information, the trusted forwarding module forwards the cryptographic operation request to a security chip that performs trusted measurements to allow the security chip to perform a trusted measurement when the instruction information indicates that the dynamic measurement module is needed to be measured.

Operation S1206: The security chip measures the dynamic measurement module according to the dynamic measurement requirement to obtain a measurement result, and sends the measurement result to a cryptographic operation chip.

The cryptographic operation request may further include a dynamic measurement requirement that indicates the cryptographic operation request being needed to be undergone a dynamic measurement.

In implementations, the security chip measures the dynamic measurement module according to the dynamic measurement requirement, and determines whether a cryptographic operation is trusted. When the measurement result indicates that the cryptographic operation is trusted, the measurement result is sent to the cryptographic operation chip, and the cryptographic operation chip is triggered to perform the cryptographic operation.

Operation S1208: The cryptographic operation chip performs a cryptographic operation when the measurement result indicates that an integrity of the dynamic measurement module is intact.

In response to receiving information that the integrity of the dynamic measurement module is intact, the cryptographic operation chip confirms that the cryptographic operation is trusted, and performs the cryptographic operation.

In implementations, the cryptographic operation method further includes: the trusted forwarding module sending the cryptographic operation request to the cryptographic operation chip for performing cryptographic operation processing when the instruction information indicates that the dynamic measurement module is not needed to be measured, and a monitoring result that is obtained indicates that a system for performing the cryptographic operation does not have an abnormal feature.

In implementations, when the instruction information indicates that a dynamic measurement is not needed, the credibility of a cryptographic operating system cannot be determined. The cryptographic operating system may be abnormal, resulting in invalid cryptographic operations. Therefore, the credibility of the cryptographic operating system is monitored.

In implementations, in response to detecting that no abnormality exists in the cryptographic operating system, the cryptographic operating system is confirmed to be trusted, and the cryptographic operation request is sent to the cryptographic operation chip for performing the cryptographic operation.

The above detection method can be the same as the one in the first embodiment.

In implementations, the cryptographic operation method further includes: the trusted forwarding module obtaining a security level of a user who sends the cryptographic operation request when the monitoring result indicates that the system performing the cryptographic operation has an abnormal feature; the trusted forwarding module sending the cryptographic operation request to the security chip when the security level of the user is a high security level, wherein the security level of the user includes: a high security level or a low security level.

In implementations, the cryptographic operating system has an abnormality, indicating that the cryptographic operating system may cause an invalid operation. In order to prevent an occurrence of an invalid operation, a security level of a user of the cryptographic operation request is determined when the cryptographic operating system is detected to be abnormal, and a determination of whether a dynamic measurement is needed to be performed for the cryptographic operation request is made based on the security level.

The method of performing a dynamic measurement described above may be the same as that in the first embodiment. For example, the dynamic measurement is performed by a security chip.

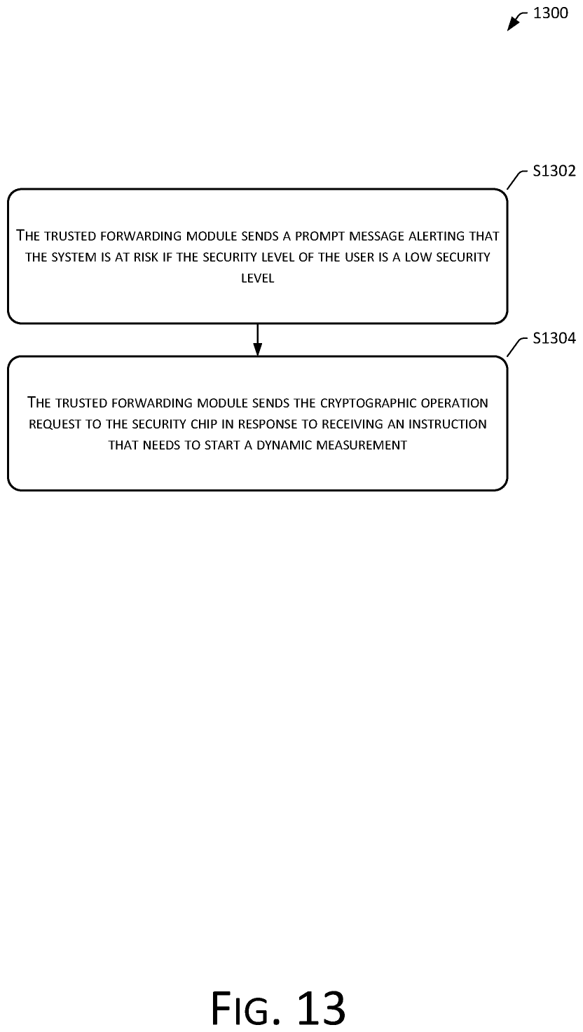

FIG. 13 is a flowchart of another cryptographic operation processing method 1300 according to sixth embodiment of the present disclosure. In addition or alternative to the operations as shown in FIG. 12, the cryptographic operation processing method 1300 may further include the following operations.

Operation S1302: The trusted forwarding module sends a prompt message alerting that the system is at risk if the security level of the user is a low security level.

Operation S1304: The trusted forwarding module sends the cryptographic operation request to the security chip in response to receiving an instruction that needs to start a dynamic measurement.

In implementations, if the security level is a low security level, and upon determining that the cryptographic operation request is not important enough for performing a dynamic measurement and the cryptographic operating system is abnormal, a prompt indicating that the cryptographic operating system is abnormal is sent to the user to prevent the cryptographic operation request from producing an invalid operation, and the user decides whether or not a dynamic measurement is needed.

In an optional embodiment, the cryptographic operation request is sent to the security chip for performing a dynamic measurement when the user confirms to perform the dynamic measurement via the prompt information.

The method of performing the dynamic measurement described above may be the same as the dynamic measurement method in the first embodiment.

In implementations, the trusted forwarding module includes: a trusted software base and a trusted software stack.

In implementations, the trusted forwarding module may be a trusted software base or a trusted software stack. The trusted software base and the trusted software stack can be functional modules in a trusted high-speed encryption card.

In the embodiments of the present disclosure, a cryptographic operation request is received by a trusted forwarding module. The cryptographic operation request includes instruction information indicating whether a dynamic measurement module is needed to be measured. The dynamic measurement module is a measurement entity used for measuring a firmware that performs cryptographic operations. The trusted forwarding module forwards the cryptographic operation request to a security chip if the instruction information indicates that the dynamic measurement module is needed to be measured. The security chip measures the dynamic measurement module according to a dynamic measurement requirement to obtain a measurement result, and sends the measurement result to a cryptographic operation chip. The cryptographic operation chip performs a cryptographic operation when the measurement result indicates that an integrity of the dynamic measurement module is intact. By monitoring a dynamic measurement requirement in a cryptographic operation request, and performing a dynamic measurement according to the dynamic requirement, the purpose of performing a dynamic measurement according to a dynamic measurement requirement of a user request is achieved. This thereby achieves the technical effects of improving user autonomy and saving computing resources, and thus solving the technical problems of an inability of satisfying user self-determination of measurements, a lack of trusted computing resources and an insecurity of computations.

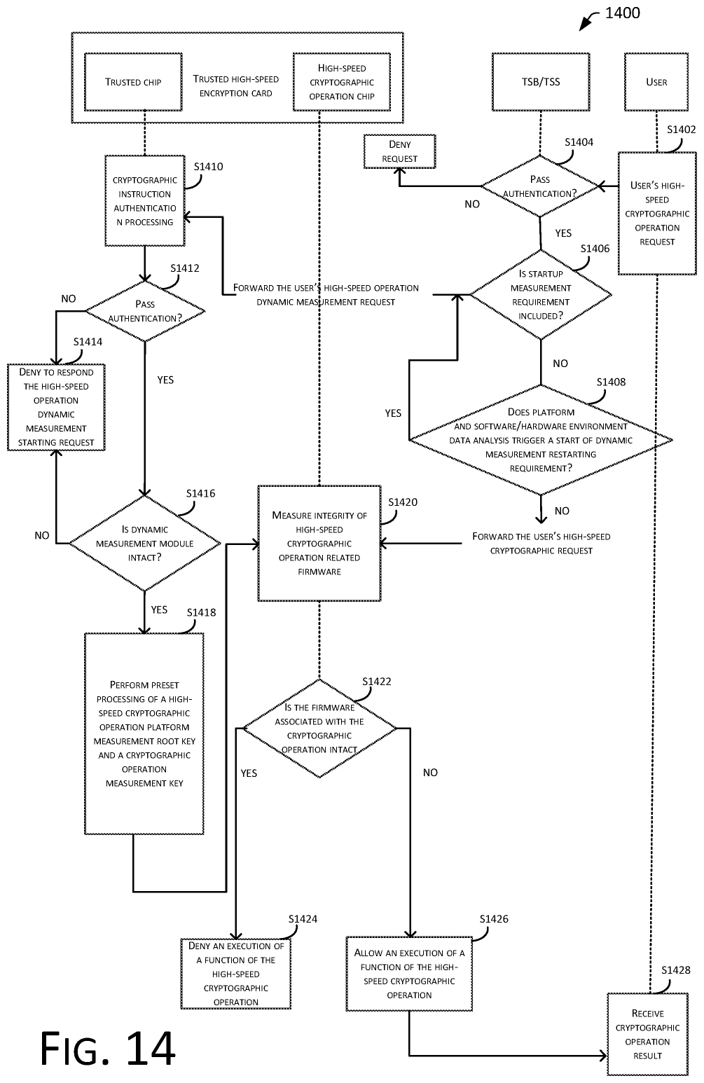

Based on the foregoing embodiments and exemplary embodiments, in order to ensure an integrity of a device, a platform, and a system while satisfying high-speed security computing requirements of a user, a trusted high-speed cryptographic operation method is provided in the exemplary embodiments of the present disclosure. FIG. 14 is a flowchart of a trusted high-speed cryptographic operation method 1400 according to the exemplary embodiments of the present disclosure. As shown in FIG. 14, the method 1400 mainly involves four entities: a user, a TSB/TSS (TSB corresponding to a trusted software base of TPCM, and TSS corresponding to a trusted software stack of TPM), a trusted chip of a trusted high-speed encryption card (corresponding to the above security chip), and a high-speed cryptographic operation chip (corresponding to the above cryptographic operation chip). Method, process and operations implementing high-speed cryptographic operations are as follows.

Operation S1402: The user sends a high-speed cryptographic operation request to the trusted high-speed encryption card through the TSB/TSS.

Operation S1404: An authentication is performed to determine the validity of the user (an authentication method may use existing authentication technologies such as the user's platform identity certificate, password, biological features, etc.) after the TSB/TSS receives the request, and the high-speed cryptographic operation request is rejected if the authentication fails, or operation S1406 is performed otherwise.

Operation S1406: The TSB/TSS identifies whether the high-speed cryptographic operation request of the user has a startup measurement requirement to satisfy the user's own needs? If having a startup dynamic measurement requirement, the startup dynamic measurement requirement of the high-speed cryptographic operation request of the user is forwarded to the trusted chip, and operation S1410 is performed; otherwise, operation S1408 is performed (an identification method can be made through a parameter in the high-speed cryptographic operation request, whether it is 1 or 0, 1 indicating that the startup measurement requirement is included, otherwise this indicates that no startup measurement requirement is included; the startup measurement requirement refers to a need of performing a trusted integrity verification on a dynamic measurement module that includes a cryptographic operation measurement root).

Operation S1408: In response to detecting that a platform and a system of a present device have abnormal features, a trusted server monitoring platform or a trusted monitoring system of the device may perform an execution of a starting function of a high-speed cryptographic operation dynamic measurement according to security level requirement of a user. If the execution is mandatory to the system or the user chooses to enforce the execution, a user request of starting the high-speed cryptographic operation dynamic measurement is forwarded to the trusted chip, and operation S1410 is performed. Otherwise, operation S1420 is performed. (For example, if the user is a high security level request, the system can enforce an execution of the starting function of the high-speed cryptographic dynamic measurement. If being a middle and low security user, the user can be prompted about risks of the platform and the system, to allow the user to decide whether to start an execution of the function of the high-speed cryptographic operation dynamic measurement. Abnormal features can be security policies such as memory, CPU occupancy rate, request frequency of the user, etc.).

Operation S1410: The trusted chip receives a user request of starting a high-speed cryptographic operation dynamic measurement forwarded by the TSS/TSB, and performs instruction authentication processing;

Operation S1412: Authentication indicates illegitimacy, and operation S1414 is performed, or operation S1416 is performed otherwise.

Operation S1414: The high speed cryptographic operation request of the user is denied.

Operation S1416: An integrity check of the dynamic measurement is performed, and operation S1414 is performed if an integrity check result indicates incompleteness, or operation S1418 is performed otherwise.

Operation S1418: Preset processing of a high-speed cryptographic operation platform measurement root key and a cryptographic operation measurement key is performed.

Operation S1420: Processing of an integrity measurement of a firmware associated with a high-speed cryptographic operation is performed.

Operation S1422: Is the firmware associated with the cryptographic operation intact? Operation S1424 is performed if affirmative, or operation S1426 is performed otherwise.

Operation S1424: An execution of a function of the high-speed cryptographic operation is denied.

Operation S1426: An execution of a function of the high-speed cryptographic operation is allowed, and an execution result is forwarded to the user.

Operation S1428: The user receives a high-speed cryptographic operation result returned by the high-speed cryptographic operation chip, and the process is ended.

Through the above embodiments and exemplary embodiments, based on a user's own needs and security level requirements, and using an intelligent environment to monitor, data mine and analyze platform and system risks, the user's request of starting a high-speed cryptographic operation dynamic measurement can be intelligently responded. Furthermore, the user's high-speed cryptographic operation request is responded only when an integrity of a dynamic measurement module and an integrity of a high-speed cryptographic operation firmware are good, thereby satisfying the performance requirement of the user's high-speed cryptographic operation, while guaranteeing computational security requirements thereof.

It should be noted that the foregoing method embodiments are all expressed as series of action combinations for the sake of simple description. One skilled in the art should understand that the present disclosure is not limited by the described orders of actions, because certain operations may be performed in other orders or in parallel in accordance with the present disclosure. In addition, one skilled in the art should also understand that the embodiments described in the specification are all exemplary embodiments, and actions and modules involved may not necessarily be essential to the present disclosure.

Through the description of the above embodiments, one skilled in the art can clearly understand that the methods according to the above embodiments can be implemented by means of software plus a necessary general hardware platform, and apparently by means of hardware. However, in many cases, the former is a better implementation. Based on such understanding, the essence of the technical solutions of the present disclosure or the parts that contribute to the existing technologies may be embodied in a form of a software product. Such computer software product is stored in a storage medium (such as ROM/RAM, a magnetic disk, an optical disk), and includes a number of instructions to cause a terminal device (which may be a cell phone, a computer, a server, or a network device, etc.) to perform the methods of various embodiments of the present disclosure.

### Seventh Embodiment

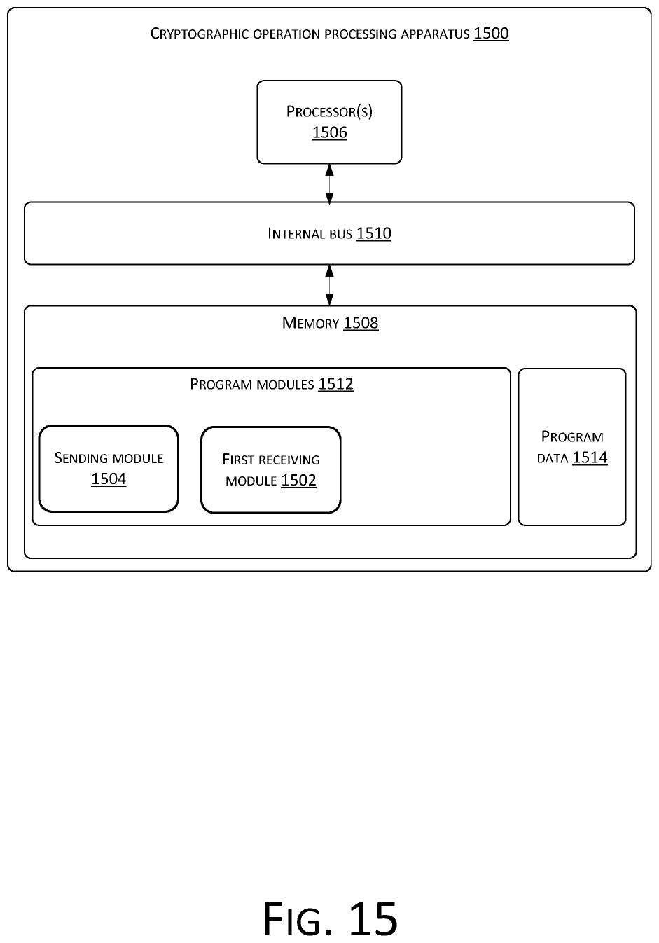

According to the embodiments of the present disclosure, a cryptographic operation processing apparatus used for implementing the above-described first embodiment is further provided. FIG. 15 is a schematic structural diagram of a cryptographic operation processing apparatus 1500 according to the seventh embodiment of the present disclosure. As shown in FIG. 15, the apparatus includes a first receiving module 1502 and a sending module 1504. The apparatus is described below.

The first receiving module 1502 is configured to receive a cryptographic operation request, and the sending module 1504 is connected to the first receiving module 1502, and configured to send the cryptographic operation request to a security chip if the cryptographic operation request has a dynamic measurement requirement. After the security chip completes the dynamic measurement requirement, a cryptographic operation chip performs cryptographic operation processing, and the dynamic measurement requirement is used to indicate that a dynamic measurement module is needed to be measured, the dynamic measurement module being a measurement entity for measuring a firmware that performs cryptographic operations.

In implementations, the apparatus 1500 may further include one or more processors 1506, a memory 1508, and an internal bus 1510. In some implementations, the apparatus 1500 may further include an input/output (I/O) interface, and a network interface.

The memory 1508 may include a form of processor readable media such as a volatile memory, a random access memory (RAM) and/or a non-volatile memory, for example, a read-only memory (ROM) or a flash RAM. The memory 820 is an example of a processor readable media.

The processor readable media may include a volatile or non-volatile type, a removable or non-removable media, which may achieve storage of information using any method or technology. The information may include a processor-readable instruction, a data structure, a program module or other data. Examples of processor storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the processor readable media does not include transitory media, such as modulated data signals and carrier waves.

In implementations, the memory 1508 may include program modules 1512 and program data 1514. The program modules 1512 may include one or more modules and/or units as described in the foregoing description and shown in FIG. 15.

It should be noted that the first receiving module 1502 and the sending module 1504 correspond to operation S502 to operation S504 in the first embodiment. Examples and application scenarios implemented by these two modules are the same as those of the corresponding operations, but are not limited to the content disclosed above in the first embodiment. It should be noted that the above modules can be operated as parts of an apparatus running in the computer terminal 100 provided in the first embodiment.

### Eighth Embodiment

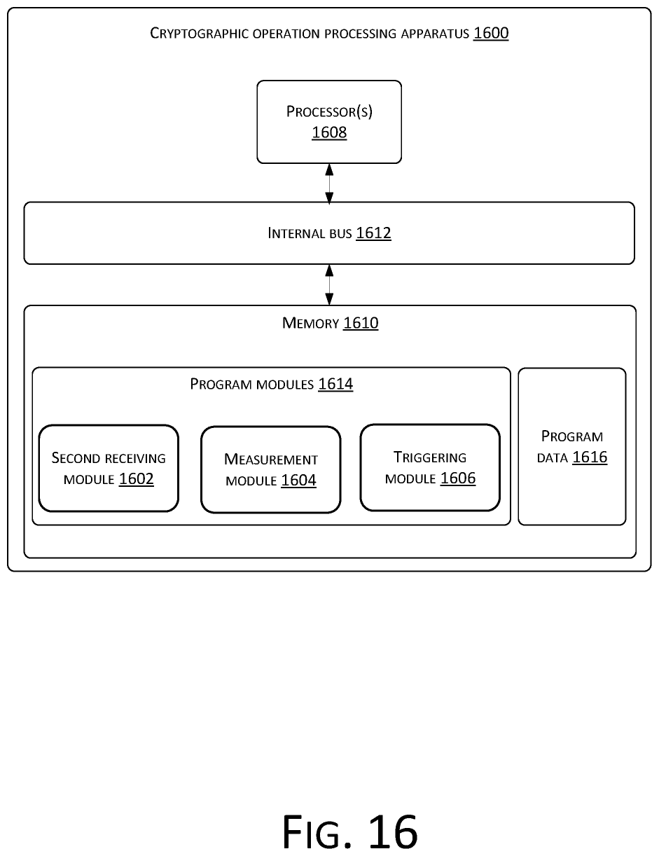

According to the embodiments of the present disclosure, a cryptographic operation processing apparatus used for implementing the second embodiment is also provided. FIG. 16 is a schematic structural diagram of a cryptographic operation processing apparatus according to the eighth embodiment of the present disclosure. As shown in FIG. 16, the apparatus includes a second receiving module 1602, a measurement module 1604, and a triggering module 1606. The apparatus is described below.

The second receiving module 1602 is configured to receive a cryptographic operation request, wherein the cryptographic operation request includes a dynamic measurement requirement, the dynamic measurement requirement is used to indicate that a dynamic measurement module is needed to be measured, and the dynamic measurement module is a measurement entity used for measuring a firmware that performs cryptographic operations. The measurement module 1604 is connected to the second receiving module 1602, and is configured to measure the dynamic measurement module according to the dynamic measurement requirement to obtain a measurement result. The triggering module 1606 is connected to the measurement module 1604, and is configured to trigger a cryptographic operation chip to perform a cryptographic operation when the measurement result indicates that an integrity of the dynamic measurement module is intact.

In implementations, the apparatus 1600 may further include one or more processors 1608, and a memory 1610, and an internal bus 1612. In some implementations, the apparatus 1600 may further include an input/output (I/O) interface, and a network interface. The memory 1610 may include a form of processor readable media as described in the foregoing description.

In implementations, the memory 1610 may include program modules 1614 and program data 1616. The program modules 1614 may include one or more modules and/or units as described in the foregoing description and shown in FIG. 16.

It should be noted that the foregoing second receiving module 1602, the measurement module 1604, and the triggering module 1606 correspond to operations 5802 to 5806 in the second embodiment. Examples and application scenarios implemented by these three modules are the same as those of the corresponding operations, but are not limited to the content disclosed above in the second embodiment. It should be noted that the above modules can be operated as parts of an apparatus running in the computer terminal 100 provided in the first embodiment.

### Ninth Embodiment

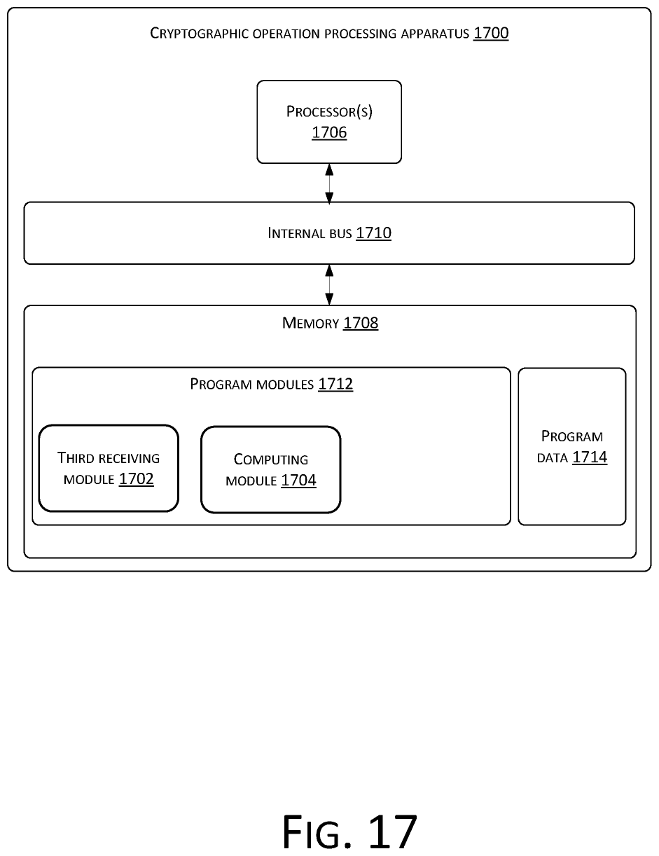

According to the embodiments of the present disclosure, a cryptographic operation processing apparatus for implementing the third embodiment is also provided. FIG. 17 is a schematic structural diagram of a cryptographic operation processing apparatus according to the ninth embodiment of the present disclosure. As shown in FIG. 17, the apparatus includes a third receiving module 1702 and a computing module 1704. The apparatus is described below.

The third receiving module 1702 is configured to receive a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations. The computing module 1704 is connected to the third receiving module 1702, and is configured to perform a cryptographic operation according to the cryptographic operation request.

In implementations, the apparatus 1700 may further include one or more processors 1706, a memory 1708, and an internal bus 1710. In some implementations, the apparatus 1700 may further include an input/output (I/O) interface, and a network interface. The memory 1708 may include a form of processor readable media as described in the foregoing description.

In implementations, the memory 1708 may include program modules 1712 and program data 1714. The program modules 1712 may include one or more modules and/or units as described in the foregoing description and shown in FIG. 17.

It should be noted that the third receiving module 1702 and the computing module 1704 correspond to operations 5902 to 5904 in the third embodiment. Examples and application scenarios implemented by these two modules are the same as those of the corresponding operations, but are not limited to the content disclosed above in the third embodiment. It should be noted that the above modules can be operated as parts of an apparatus running in the computer terminal 100 provided in the first embodiment.

### Tenth Embodiment

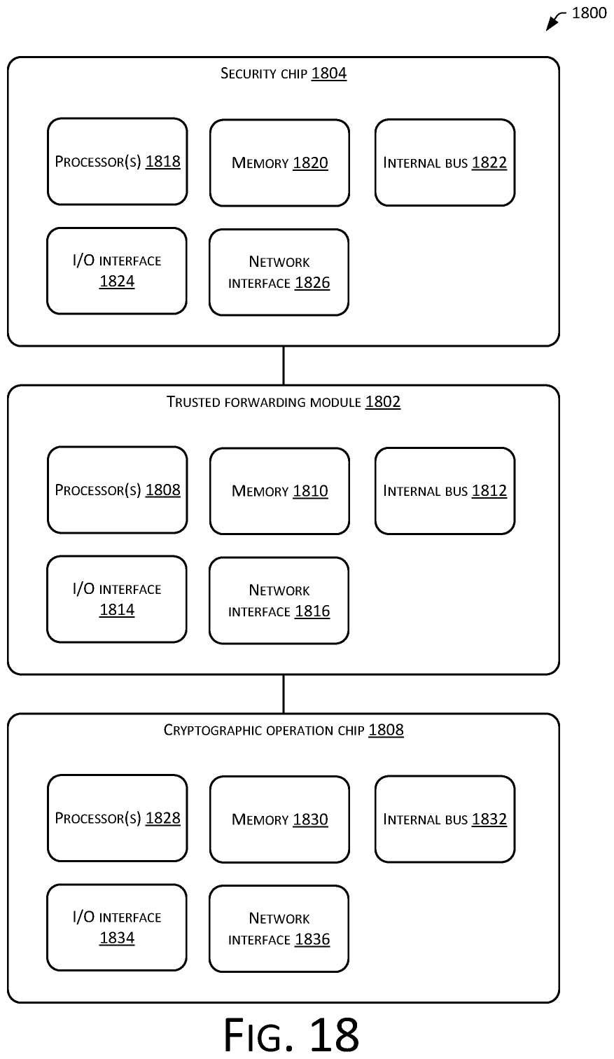

According to the embodiments of the present disclosure, a cryptographic operation processing system is further provided. FIG. 18 is a schematic structural diagram of a cryptographic operation processing system according to the tenth embodiment of the present disclosure. As shown in FIG. 18, the system includes: a trusted forwarding module 1802, a security chip 1804, and a cryptographic operation chip 1806. The system is described below.

The trusted forwarding module 1802 is configured to receive a cryptographic operation request, wherein the cryptographic operation request includes instruction information indicating whether a dynamic measurement module is needed to be measured, and the dynamic measurement module is a measurement entity configured to measure a firmware that performs cryptographic operations. The trusted forwarding module 1802 is further configured to forward the cryptographic operation request to the security chip if the instruction information indicates that the dynamic measurement module is needed to be measured. The security chip 1804 communicates with the trusted forwarding module 1802, and is configured to measure the dynamic measurement module according to a dynamic measurement requirement to obtain a measurement result, and send the measurement result to the cryptographic operation chip. The cryptographic operation chip 1806 communicates with the trusted forwarding module 1802, and is configured to perform a cryptographic operation when the measurement result indicates that an integrity of a dynamic measurement module is intact.

In implementations, the trusted forwarding module 1802 may include one or more processors 1808, a memory 1810, an internal bus 1812, an input/output (I/O) interface 1814, and a network interface 1816. In implementations, the security chip 1804 may include one or more processors 1818, a memory 1820, an internal bus 1822, an input/output (I/O) interface 1824, and a network interface 1826. In implementations, the cryptographic operation chip 1806 may include one or more processors 1828, a memory 1830, an internal bus 1832, an input/output (I/O) interface 1834, and a network interface 1836.

### Eleventh Embodiment

The embodiments of the present disclosure may provide a computer terminal. The computer terminal may be any computer terminal of a group of computer terminals. Optionally, in the present embodiment, the computer terminal may also be replaced with a terminal device such as a mobile terminal.

Optionally, in the present embodiment, the computer terminal may be located in at least one network device of a plurality of network devices of a computer network.

In the present embodiment, the computer terminal may execute program codes of the following operations in a cryptographic operation processing method of an application program: a trusted forwarding module receiving a cryptographic operation request; and the trusted forwarding module transmitting the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

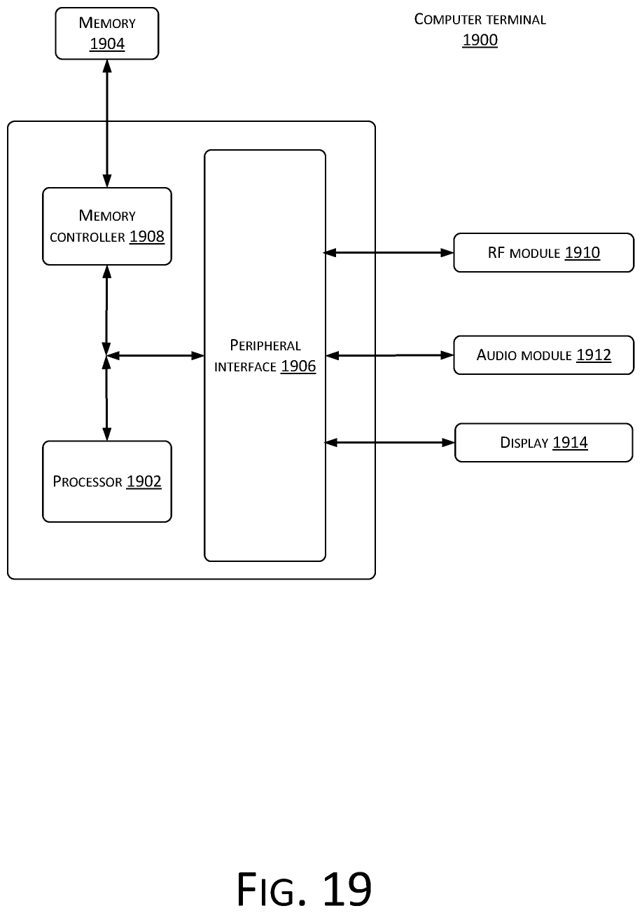

Optionally, FIG. 19 is a block diagram showing a structure of a computer terminal 1900 according to the eleventh embodiment of the present disclosure. As shown in FIG. 19, the computer terminal 1900 may include one or more (only one shown) processors 1902, a memory 1904, and a peripheral interface 1906. In implementations, the computer terminal 1900 may further include a memory controller 1908. In implementations, the computer terminal 1900 may be associated or connected with peripheral devices such as a radio frequency (RF) module 1910, an audio module 1912, and a display 1914.

The memory 1904 can be configured to store software programs and modules, such as program instructions/modules corresponding to the cryptographic operation processing methods and apparatuses in the embodiments of the present disclosure. The processor(s) 1902 executes various functions, applications and data processing by running software program(s) and module(s) stored in the memory 1904, i.e., implementing the above-described cryptographic operation processing methods. The memory 1904 may include a high speed random access memory, and may also include non-volatile memory such as one or more magnetic storage devices, a flash memory, or other non-volatile solid state memory. In some examples, the memory can further include storage devices remotely located relative to the processor(s). These storage devices can be connected to the computer terminal 1900 via a network. Examples of such network include, but are not limited to, the Internet, an intranet, a local area network, a mobile communication network, and a combination thereof.

The processor may call information and application program(s) stored in the memory through a transmission device to perform the following operations: a trusted forwarding module receiving a cryptographic operation request; and the trusted forwarding module transmitting the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

Optionally, the processor(s) may further execute program codes of the following operations: the trusted forwarding module obtaining a monitoring result when the cryptographic operation request does not have a dynamic measurement requirement, wherein the monitoring result indicates whether a system performing cryptographic operations has an abnormal feature; and the trusted forwarding module sending the cryptographic operation request to the cryptographic operation chip to perform a cryptographic operation if the monitoring result indicates that the system performing cryptographic operations does not have an abnormal feature.

Optionally, the processor may further execute program codes of the following operations: the trusted forwarding module obtaining a security level of a user who sends the cryptographic operation request when the monitoring result indicates that the system performing cryptographic operations has an abnormal feature; and the trusted forwarding module sending the cryptographic operation request to the security chip when the security level of the user is a high security level, wherein security levels of users include: the high security level and a low security level.

Optionally, the processor may further execute program codes of the following operations: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Optionally, the processor may further execute program codes of the following operations: after the trusted forwarding module receives the cryptographic operation request, the trusted forwarding module obtaining a requirement parameter included in the cryptographic operation request, wherein the requirement parameter is used to indicate whether the dynamic measurement requirement exists; and the trusted forwarding module determining whether the cryptographic operation request has the dynamic measurement requirement according to the requirement parameter.

Optionally, the processor may further execute program codes of the following operations: after the trusted forwarding module receives the cryptographic operation request, the trusted forwarding module verifying the validity of the cryptographic operation request according to a user platform identity certificate included in the cryptographic operation request, and allowing the cryptographic operation request to be forwarded upon successful verification.

Optionally, the processor may further execute program codes of the following operations: a security chip receiving a cryptographic operation request, wherein the cryptographic operation request includes a dynamic measurement requirement, the dynamic measurement requirement is used to indicate that a dynamic measurement module is needed to be measured, the dynamic measurement module is a measurement entity used for measuring a firmware that performs cryptographic operations; the security chip measuring the dynamic measurement module according to the dynamic measurement requirement to obtain a measurement result; and the security chip triggering a cryptographic operation chip to perform a cryptographic operation when the measurement result indicates that an integrity of the dynamic measurement module is intact.

Optionally, the processor may further execute program codes of the following operations: after the security chip receives the cryptographic operation request, the security chip verifying the legitimacy of the cryptographic operation request, and allowing the dynamic measurement module to be measured upon successful verification.

Optionally, the processor may further execute program codes of the following operations: a cryptographic operation chip receiving a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations; and the cryptographic operation chip performing a cryptographic operation based on the cryptographic operation request.

Optionally, the processor may further execute program codes of the following operations: an encryption card receiving a cryptographic operation request when a dynamic measurement requirement exists; and the encryption card performing cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Optionally, the processor may further execute program codes of the following operations: a security chip in an encryption card receiving a cryptographic operation request when a dynamic measurement requirement exists; the security chip in the encryption card triggering a cryptographic operation chip in the encryption card to perform cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Optionally, the processor may further execute program codes of the following operations: a trusted forwarding module receiving a cryptographic operation request, wherein the cryptographic operation request includes instruction information indicating whether a dynamic measurement module is needed to be measured, and the dynamic measurement module is a measurement entity used for measuring a firmware that performs cryptographic operations; the trusted forwarding module forwarding the cryptographic operation request to a security chip if the instruction information indicates that the dynamic measurement module is needed to be measured; the security chip measuring the dynamic measurement module according to the dynamic measurement requirement to obtain a measurement result, and sending the measurement result to a cryptographic operation chip; and the cryptographic operation chip performing a cryptographic operation when the measurement result indicates that an integrity of the dynamic measurement module is intact.

Optionally, the processor may further execute program codes of the following operations: the trusted forwarding module sending the cryptographic operation request to the cryptographic operation chip for performing the cryptographic operation processing when the instruction information indicates that the dynamic measurement module is not needed to be measured, and an obtained monitoring result indicates that a system performing cryptographic operations has no abnormal feature.

Optionally, the processor may further execute program codes of the following operations: the trusted forwarding module obtaining a security level of a user who sends the cryptographic operation request if the monitoring result indicates that the system performing the cryptographic operations has an abnormal feature; and the trusted forwarding module sending the cryptographic operation request to the security chip when the security level of the user is a high security level, wherein the security level of the user includes: the high security level and a low security level.

Optionally, the processor may further execute program codes of the following operations: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Optionally, the trusted forwarding module includes: a trusted software base, and a trusted software stack.

In the embodiments of the present disclosure, a trusted forwarding module can receive a cryptographic operation request, wherein the cryptographic operation request includes instruction information indicating whether a dynamic measurement module is needed to be measured, and the dynamic measurement module is a measurement entity used for measuring a firmware that performs cryptographic operations. The trusted forwarding module forwards the cryptographic operation request to a security chip if the instruction information indicates that the dynamic measurement module is needed to be measured. The security chip measures the dynamic measurement module according to a dynamic measurement requirement, obtains a measurement result, and sends the measurement result to a cryptographic operation chip. The cryptographic operation chip performs a cryptographic operation if the measurement result indicates that an integrity of the dynamic measurement module is intact. By monitoring a dynamic measurement requirement in a cryptographic operation request, and performing a dynamic measurement according to the dynamic measurement requirement, the purpose of performing a dynamic measurement according to a dynamic measurement requirement in a user request, thereby realizing the technical effects of improving user independence and saving computing resources, and thus solving the technical problems of failing to satisfy the independent needs of users with respect to measurements, lacking trusted computing resources, and having computational insecurity.

One skilled in the art can understand that the structure shown in FIG. 19 is merely illustrative, and the computer terminal can also be a smart phone (such as an Android mobile phone, an iOS mobile phone, etc.), a tablet computer, a handheld computer, a mobile Internet device (MID), a PAD, or other terminal devices. FIG. 19 does not limit the structure of the above electronic device. For example, the computer terminal 190 may also include more or fewer components (such as a network interface, a display device, etc.) than those shown in FIG. 19, or have a configuration different from the one shown in FIG. 19.

One of ordinary skill in the art can understand that all or part of the operations of the foregoing embodiments may be completed through instructing related hardware of a terminal device by a program. Such program may be stored in a computer readable storage medium, and the storage medium may include a flash disk, a read-only memory (ROM), a random access memory (RAM), a magnetic disk, or an optical disk.

### Twelfth Embodiment

The embodiments of the present disclosure also provide a storage medium. Optionally, in the present embodiment, the storage medium may be configured to store program codes executed by the cryptographic operation processing method provided in the first embodiment.

Optionally, in the present embodiment, the storage medium may be located in any computer terminal of a group of computer terminals in a computer network, or in any mobile terminal of a group of mobile terminals.

Optionally, in the present embodiment, the storage medium is configured to store program codes for performing the following operations: a trusted forwarding module receiving a cryptographic operation request; and the trusted forwarding module transmitting the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

Optionally, in the present embodiment, the storage medium is configured to store program codes for performing the following operations: the trusted forwarding module obtaining a monitoring result when the cryptographic operation request does not have a dynamic measurement requirement, wherein the monitoring result indicates whether a system performing cryptographic operations has an abnormal feature; and the trusted forwarding module sending the cryptographic operation request to the cryptographic operation chip to perform a cryptographic operation if the monitoring result indicates that the system performing cryptographic operations does not have an abnormal feature.

Optionally, in the present embodiment, the storage medium is configured to store program codes for performing the following operations: the trusted forwarding module obtaining a security level of a user who sends the cryptographic operation request when the monitoring result indicates that the system performing cryptographic operations has an abnormal feature; and the trusted forwarding module sending the cryptographic operation request to the security chip when the security level of the user is a high security level, wherein security levels of users include: the high security level and a low security level.

Optionally, in the present embodiment, the storage medium is configured to store program codes for performing the following operations: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Optionally, in the present embodiment, the storage medium is configured to store program codes for performing the following operations: after the trusted forwarding module receives the cryptographic operation request, the trusted forwarding module obtaining a requirement parameter included in the cryptographic operation request, wherein the requirement parameter is used to indicate whether the dynamic measurement requirement exists; and the trusted forwarding module determining whether the cryptographic operation request has the dynamic measurement requirement according to the requirement parameter.

Optionally, in the present embodiment, the storage medium is configured to store program codes for performing the following operations: after the trusted forwarding module receives the cryptographic operation request, the trusted forwarding module verifying the validity of the cryptographic operation request according to a user platform identity certificate included in the cryptographic operation request, and allowing the cryptographic operation request to be forwarded upon successful verification.

Optionally, in the present embodiment, the storage medium is configured to store program codes for performing the following operations: a security chip receiving a cryptographic operation request, wherein the cryptographic operation request includes a dynamic measurement requirement, the dynamic measurement requirement is used to indicate that a dynamic measurement module is needed to be measured, the dynamic measurement module is a measurement entity used for measuring a firmware that performs cryptographic operations; the security chip measuring the dynamic measurement module according to the dynamic measurement requirement to obtain a measurement result; and the security chip triggering a cryptographic operation chip to perform a cryptographic operation when the measurement result indicates that an integrity of the dynamic measurement module is intact.

Optionally, in the present embodiment, the storage medium is configured to store program codes for performing the following operations: after the security chip receives the cryptographic operation request, the security chip verifying the legitimacy of the cryptographic operation request, and allowing the dynamic measurement module to be measured upon successful verification.

Optionally, in the present embodiment, the storage medium is configured to store program codes for performing the following operations: a cryptographic operation chip receiving a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations; and the cryptographic operation chip performing a cryptographic operation based on the cryptographic operation request.

Optionally, in the present embodiment, the storage medium is arranged to store program codes for performing the following operations: an encryption card receiving a cryptographic operation request when a dynamic measurement requirement exists; and the encryption card performing cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Optionally, in the present embodiment, the storage medium is arranged to store program codes for performing the following operations: a security chip in an encryption card receiving a cryptographic operation request when a dynamic measurement requirement exists; the security chip in the encryption card triggering a cryptographic operation chip in the encryption card to perform cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Optionally, in the present embodiment, the storage medium is arranged to store program codes for performing the following operations: a trusted forwarding module receiving a cryptographic operation request, wherein the cryptographic operation request includes instruction information indicating whether a dynamic measurement module is needed to be measured, and the dynamic measurement module is a measurement entity used for measuring a firmware that performs cryptographic operations; the trusted forwarding module forwarding the cryptographic operation request to a security chip if the instruction information indicates that the dynamic measurement module is needed to be measured; the security chip measuring the dynamic measurement module according to the dynamic measurement requirement to obtain a measurement result, and sending the measurement result to a cryptographic operation chip; and the cryptographic operation chip performing a cryptographic operation when the measurement result indicates that an integrity of the dynamic measurement module is intact.

Optionally, in the present embodiment, the storage medium is arranged to store program codes for performing the following operations: the trusted forwarding module sending the cryptographic operation request to the cryptographic operation chip for performing the cryptographic operation processing when the instruction information indicates that the dynamic measurement module is not needed to be measured, and an obtained monitoring result indicates that a system performing cryptographic operations has no abnormal feature.

Optionally, in the present embodiment, the storage medium is arranged to store program codes for performing the following operations: the trusted forwarding module obtaining a security level of a user who sends the cryptographic operation request if the monitoring result indicates that the system performing the cryptographic operations has an abnormal feature; and the trusted forwarding module sending the cryptographic operation request to the security chip when the security level of the user is a high security level, wherein the security level of the user includes: the high security level and a low security level.

Optionally, in the present embodiment, the storage medium is arranged to store program codes for performing the following operations: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Optionally, in the present embodiment, the trusted forwarding module includes: a trusted software base, and a trusted software stack.

The serial numbers of the embodiments of the present disclosure are merely used for description, and do not represent advantages and disadvantages of the embodiments.

In the foregoing embodiments of the present disclosure, descriptions of various embodiments are different, and the parts that are not detailed in a certain embodiment can be referenced to related descriptions of other embodiments.

In a number of embodiments provided by the present application, it should be understood that technical content that is disclosed can be implemented in other manners. The apparatus embodiments described above are merely illustrative. For example, a division of units is only a logical division of functions. In real implementations, other manners of division can exist. For example, multiple units or components may be combined or may be integrated into another system, or some features can be ignored or not executed. In addition, a mutual coupling or a direct coupling or a communication connection that is shown or discussed may be an indirect coupling or communication connection through some interface(s), unit(s) or module(s), and may be in an electrical or other form.

The units described as separate components may or may not be physically separated, and the components displayed as units may or may not be physical units, i.e., may be located in one place, or may be distributed among multiple network units. Some or all of the units may be selected according to actual needs to achieve the purpose of the solutions of the embodiments.

In addition, various functional units in each embodiment of the present disclosure may be integrated into one processing unit. Alternatively, each unit may exist as a physically independent entity. Alternatively, two or more units may be integrated into one unit. The above integrated unit can be implemented in a form of hardware or in a form of a software functional unit.

The integrated unit, if being implemented in a form of a software functional unit and sold or used as a standalone product, may be stored in a computer readable storage medium. Based on such understanding, the essence of the technical solutions of the present disclosure, or the parts that make contributions to the existing technologies, or all or parts of the technical solutions, may be embodied in a form of a software product. Such computer software product is stored in a storage medium, and includes a number of instructions to cause a computing device (which may be a personal computer, a server or a network device, etc.) to perform all or part of the operations of the methods described in various embodiments of the present disclosure. The storage medium includes: a U disk, a Read-Only Memory (ROM), a Random Access Memory (RAM), a removable hard disk, a magnetic disk, or an optical disk, etc.

The above only describes the exemplary embodiments of the present disclosure. It should be noted that one skilled in the art can also make a number of improvements and polishing without departing from the principles of the present disclosure. These improvements and polishing should be considered to fall within the scope of protection of the present disclosure.

The present disclosure can be further understood using the following clauses.

Clause 1: A cryptographic operation processing method comprising: a trusted forwarding module receiving a cryptographic operation request; and the trusted forwarding module sending the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

Clause 2: The method of Clause 1, further comprising: the trusted forwarding module obtaining a monitoring result when the cryptographic operation request does not have a dynamic measurement requirement, wherein the monitoring result indicates whether a system performing cryptographic operations has an abnormal feature; and the trusted forwarding module sending the cryptographic operation request to the cryptographic operation chip to perform a cryptographic operation if the monitoring result indicates that the system performing cryptographic operations does not have an abnormal feature.

Clause 3: The method of Clause 2, further comprising: the trusted forwarding module obtaining a security level of a user who sends the cryptographic operation request when the monitoring result indicates that the system performing cryptographic operations has an abnormal feature; and the trusted forwarding module sending the cryptographic operation request to the security chip when the security level of the user is a high security level, wherein security levels of users include: the high security level and a low security level.

Clause 4: The method of Clause 3, further comprising: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Clause 5: The method of Clause 1, wherein: after the trusted forwarding module receives the cryptographic operation request, the method further comprises: the trusted forwarding module obtaining a requirement parameter included in the cryptographic operation request, wherein the requirement parameter is used to indicate whether the dynamic measurement requirement exists; and the trusted forwarding module determining whether the cryptographic operation request has the dynamic measurement requirement according to the requirement parameter.

Clause 6: The method of any one of Clauses 1-5, wherein: after the trusted forwarding module receives the cryptographic operation request, the method further comprises: the trusted forwarding module verifying the validity of the cryptographic operation request according to a user platform identity certificate included in the cryptographic operation request, and allowing the cryptographic operation request to be forwarded upon successful verification.

Clause 7: A cryptographic operation processing method comprising: a security chip receiving a cryptographic operation request, wherein the cryptographic operation request includes a dynamic measurement requirement, the dynamic measurement requirement is used to indicate that a dynamic measurement module is needed to be measured, the dynamic measurement module is a measurement entity used for measuring a firmware that performs cryptographic operations; the security chip measuring the dynamic measurement module according to the dynamic measurement requirement to obtain a measurement result; and the security chip triggering a cryptographic operation chip to perform a cryptographic operation when the measurement result indicates that an integrity of the dynamic measurement module is intact.

Clause 8: The method of Clause 7, wherein: after the security chip receives the cryptographic operation request, the method further comprises: the security chip verifying the legitimacy of the cryptographic operation request, and allowing the dynamic measurement module to be measured upon successful verification.

Clause 9: A cryptographic operation processing method comprising: a cryptographic operation chip receiving a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations; and the cryptographic operation chip performing a cryptographic operation based on the cryptographic operation request.

Clause 10: A cryptographic operation processing method comprising: an encryption card receiving a cryptographic operation request when a dynamic measurement requirement exists; and the encryption card performing cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Clause 11: A cryptographic operation processing method comprising: a security chip in an encryption card receiving a cryptographic operation request when a dynamic measurement requirement exists; the security chip in the encryption card triggering a cryptographic operation chip in the encryption card to perform cryptographic operation processing if the encryption card completes the dynamic measurement requirement, wherein the dynamic measurement requirement is used to indicate that a dynamic measurement module is needed to be measured, and the dynamic measurement module is a measurement entity used for measuring a firmware that performs cryptographic operations.

Clause 12: A cryptographic operation processing method comprising: a trusted forwarding module receiving a cryptographic operation request, wherein the cryptographic operation request includes instruction information indicating whether a dynamic measurement module is needed to be measured, and the dynamic measurement module is a measurement entity used for measuring a firmware that performs cryptographic operations; the trusted forwarding module forwarding the cryptographic operation request to a security chip if the instruction information indicates that the dynamic measurement module is needed to be measured; the security chip measuring the dynamic measurement module according to the dynamic measurement requirement to obtain a measurement result, and sending the measurement result to a cryptographic operation chip; and the cryptographic operation chip performing a cryptographic operation when the measurement result indicates that an integrity of the dynamic measurement module is intact.

Clause 13: The method of Clause 12, further comprising: the trusted forwarding module sending the cryptographic operation request to the cryptographic operation chip for performing the cryptographic operation processing when the instruction information indicates that the dynamic measurement module is not needed to be measured, and an obtained monitoring result indicates that a system performing cryptographic operations has no abnormal feature.

Clause 14: The method of Clause 13, further comprising: the trusted forwarding module obtaining a security level of a user who sends the cryptographic operation request if the monitoring result indicates that the system performing the cryptographic operations has an abnormal feature; and the trusted forwarding module sending the cryptographic operation request to the security chip when the security level of the user is a high security level, wherein the security level of the user includes: the high security level and a low security level.

Clause 15: The method of Clause 14, further comprising: the trusted forwarding module sending prompt information indicating that the system is at risk when the security level of the user is a low security level; and the trusted forwarding module sending the cryptographic operation request to the security chip after receiving an instruction indicating a need to start a dynamic measurement.

Clause 16: The method of any one of Clauses 12-15, wherein the trusted forwarding module includes: a trusted software base, and a trusted software stack.

Clause 17: A cryptographic operation processing apparatus, which is applied to a trusted forwarding module, comprising: a first receiving module configured to receive a cryptographic operation request; and a sending module connected to the first receiving module, and configured to send the cryptographic operation request to a security chip if the cryptographic operation request has a dynamic measurement requirement, wherein a cryptographic operation chip performs cryptographic operation processing after the security chip completes the dynamic measurement requirement, and the dynamic measurement requirement is used to indicate that a dynamic measurement module is needed to be measured, the dynamic measurement module being a measurement entity for measuring a firmware that performs cryptographic operations.

Clause 18: A cryptographic operation processing apparatus, which is applied to a security chip, comprising: a second receiving module configured to receive a cryptographic operation request, wherein the cryptographic operation request includes a dynamic measurement requirement, the dynamic measurement requirement is used to indicate that a dynamic measurement module is needed to be measured, and the dynamic measurement module is a measurement entity used for measuring a firmware that performs cryptographic operations; a measurement module connected to the second receiving module, and configured to measure the dynamic measurement module according to the dynamic measurement requirement to obtain a measurement result; and a triggering module connected to the measurement module, and configured to trigger a cryptographic operation chip to perform a cryptographic operation when the measurement result indicates that an integrity of the dynamic measurement module is intact.

Clause 19: A cryptographic operation processing apparatus, which is applied to a cryptographic operation chip, comprising: a receiving module configured to receive a cryptographic operation request, wherein the cryptographic operation request includes instruction information, the instruction information is used to indicate that a dynamic measurement module is not needed to be measured, and the dynamic measurement module is a measurement entity used for measuring a firmware that performs cryptographic operations; and a computing module connected to the receiving module, and configured to perform a cryptographic operation according to the cryptographic operation request.

Clause 20: A cryptographic operation processing system comprising: a trusted forwarding module, a security chip, and a cryptographic operation chip, wherein: the trusted forwarding module is configured to receive a cryptographic operation request, wherein the cryptographic operation request includes instruction information indicating whether a dynamic measurement module is needed to be measured, and the dynamic measurement module is a measurement entity configured to measure a firmware that performs cryptographic operations; the trusted forwarding module is further configured to forward the cryptographic operation request to the security chip if the instruction information indicates that the dynamic measurement module is needed to be measured; the security chip communicates with the trusted forwarding module, and is configured to measure the dynamic measurement module according to a dynamic measurement requirement to obtain a measurement result, and send the measurement result to the cryptographic operation chip; and the cryptographic operation chip communicates with the trusted forwarding module, and is configured to perform a cryptographic operation when the measurement result indicates that an integrity of a dynamic measurement module is intact.

Clause 21: The system of Clause 20, wherein the trusted forwarding module includes: a trusted software base, and a trusted software stack.

Clause 22: A storage medium comprising a stored program, wherein the program, when executed, controls a device in which the storage medium is located to perform the cryptographic operation processing method of any one of Clauses 1-16.

Clause 23: A processor configured to run a program, wherein the program, when executed, controls a device in which the storage medium is located to perform the cryptographic operation processing method of any one of Clauses 1-16.

What is claimed is:

1. One or more processor readable media storing executable instructions that, when executed by one or more processors of a trusted forwarding module, cause the one or more processors to perform acts comprising:
receiving a cryptographic operation request; and
sending the cryptographic operation request to a security chip if the cryptographic operation request has a dynamic measurement requirement, wherein a cryptographic operation chip performs cryptographic operation processing after the security chip completes the dynamic measurement requirement, the dynamic measurement requirement being used for indicating that a dynamic measurement module is needed to be measured, and the dynamic measurement module being a measurement entity used for measuring a firmware that performs cryptographic operations.

2. The one or more processor readable media of claim 1, the acts further comprising:
obtaining a monitoring result when the cryptographic operation request does not have a dynamic measurement requirement, wherein the monitoring result indicates whether a system performing cryptographic operations has an abnormal feature.

3. The one or more processor readable media method of claim 2, the acts further comprising:
sending the cryptographic operation request to the cryptographic operation chip to perform a cryptographic operation if the monitoring result indicates that the system performing cryptographic operations does not have an abnormal feature.

4. The one or more processor readable media of claim 2, the acts further comprising:
obtaining a security level of a user who sends the cryptographic operation request when the monitoring result indicates that the system performing cryptographic operations has an abnormal feature.

5. The one or more processor readable media of claim 4, the acts further comprising:
sending the cryptographic operation request to the security chip when the security level of the user is a high security level, wherein security levels of users include: the high security level and a low security level.

6. The one or more processor readable media of claim 4, the acts further comprising:
sending prompt information indicating that the system is at risk when the security level of the user is a low security level; and
sending the cryptographic operation request to the security chip after receiving an instruction indicating a need to start a dynamic measurement.

7. The one or more processor readable media of claim 1, the acts further comprising:
obtaining a requirement parameter included in the cryptographic operation request after receiving the cryptographic operation request, wherein the requirement parameter is used to indicate whether the dynamic measurement requirement exists; and
determining whether the cryptographic operation request has the dynamic measurement requirement according to the requirement parameter.

8. The one or more processor readable media of claim 1, the acts further comprising:
verifying validity of the cryptographic operation request according to a user platform identity certificate included in the cryptographic operation request after receiving the cryptographic operation request, and allowing the cryptographic operation request to be forwarded upon successful verification.

9. A method implemented by a security chip comprising one or more processors and memory, the method comprising:
receiving a cryptographic operation request, wherein the cryptographic operation request includes a dynamic measurement requirement, the dynamic measurement requirement is used to indicate that a dynamic measurement module is needed to be measured;
measuring the dynamic measurement module according to the dynamic measurement requirement to obtain a measurement result; and
a cryptographic operation chip to perform a cryptographic operation when the measurement result indicates that an integrity of the dynamic measurement module is intact.

10. The method of claim 9, wherein, the dynamic measurement module is a measurement entity used for measuring a firmware that performs cryptographic operations.

11. The method of claim 9, further comprising:
verifying legitimacy of the cryptographic operation request after receiving the cryptographic operation request; and
allowing the dynamic measurement module to be measured upon successful verification.

12. A system comprising:
a trusted forwarding module comprising one or more processors and memory, the trusted forwarding module being configured to:
receive a cryptographic operation request, wherein the cryptographic operation request includes instruction information indicating whether a dynamic measurement module is needed to be measured, and the dynamic measurement module is a measurement entity used for measuring a firmware that performs cryptographic operations; and
forward the cryptographic operation request to a security chip or a cryptographic operation chip based on whether the instruction information indicates that the dynamic measurement module is needed to be measured.

13. The system of claim 12, wherein the trusted forwarding module forwards the cryptographic operation request to the security chip when the instruction information indicates that the dynamic measurement module is needed to be measured.

14. The system of claim 13, wherein the security chip is configured to measure the dynamic measurement module according to the dynamic measurement requirement to obtain a measurement result, and send the measurement result to a cryptographic operation chip, to cause the cryptographic operation chip to perform a cryptographic operation when the measurement result indicates that an integrity of the dynamic measurement module is intact.

15. The system of claim 12, wherein the trusted forwarding module forwards the cryptographic operation request to the cryptographic operation chip for performing the cryptographic operation processing when the instruction information indicates that the dynamic measurement module is not needed to be measured, and an obtained monitoring result indicates that a system performing cryptographic operations has no abnormal feature.

16. The system of claim 15, wherein the trusted forwarding module is further configured to obtain a security level of a user who sends the cryptographic operation request if the monitoring result indicates that the system performing the cryptographic operations has an abnormal feature.

17. The system of claim 16, wherein the trusted forwarding module is further configured to send the cryptographic operation request to the security chip when the security level of the user is a high security level.

18. The system of claim 16, wherein the trusted forwarding module sends prompt information indicating that the system is at risk when the security level of the user is a low security level.

19. The system of claim 18, wherein the trusted forwarding module sends the cryptographic operation request to the security chip after receiving an instruction indicating a need to start a dynamic measurement.

20. The system of claim 12, wherein the trusted forwarding module comprises: a trusted software base, and a trusted software stack.
